(19) United States
(12) Patent Application Publication
(10) Pub. No.: US 2020/0212594 A1
(43) Pub. Date: Jul. 2, 2020

(54) ANTENNA DEVICE

(71) Applicants: Nidec Corporation, Kyoto (JP); WGR Co., Ltd., Kyoto-city (JP)

(72) Inventors: Hideki KIRINO, Kyoto-city (JP); Yosuke SATO, Kyoto (JP); Hiroyuki KAMO, Kyoto (JP)

(21) Appl. No.: 16/727,359

(22) Filed: Dec. 26, 2019

(30) Foreign Application Priority Data
Dec. 27, 2018 (JP) 2018-244692

(51) Int. Cl. H01Q 21/06; H01Q 13/02; H01Q 13/18; H01P 3/123; H01Q 21/00; H01Q 5/55; G01S 13/86; G01S 7/285; G01S 7/282

(52) U.S. Cl. CPC H01Q 21/064; H01Q 13/02; H01Q 13/18; H01P 3/123; G01S 7/282; H01Q 5/55; G01S 13/86; G01S 7/285; H01Q 21/005

(57) ABSTRACT

An antenna device includes an electrical conductor including an electrically conductive surface and a slot in the electrically conductive surface, a pair of electrically-conductive side walls on opposite sides of the slot and protruding from the electrically conductive surface and flanking each other along a first direction, and each side wall extending along a second direction intersecting the first direction, and a pair of electrically-conductive ridges each protruding from the electrically conductive surface and extending along the second direction and including an end surface, the respective end surfaces of the pair of ridges opposing each other via a gap overlapping a central portion of the slot as viewed from a third direction perpendicular to the electrically conductive surface. A waveguide continuous with an external space is defined in a space inside the slot and between the end surfaces of the pair of ridges.

### CROSS REFERENCE TO RELATED APPLICATION

The present invention claims priority under 35 U.S.C. § 119 to Japanese Application No. 2018-244692 filed on Dec. 27, 2018, the entire contents of which are hereby incorporated herein by reference.

### FIELD OF THE INVENTION

The present disclosure relates to an antenna device.

### BACKGROUND

Horn antennas have favorable characteristics, such as an ability to radiate or receive electromagnetic waves across a relatively wide frequency band. Therefore, antenna devices with a horn antenna are widely used. For example, U.S. Pat. No. 5,359,339 discloses an example of a horn antenna that includes a pair of ridges defining steps inside a horn. In the present specification, any such horn antenna that includes a pair of ridges will be referred to as a “ridge horn antenna”, or simply as a “ridge horn”.

A ridge horn is capable of operation across a relatively wide frequency band. However, when radiating or receiving an electromagnetic wave, an electric field will concentrate between the pair of ridges, which means that an electric field is likely to concentrate in the central portion of the horn opening, as compared to a generic horn antenna that lacks ridges. Although such characteristics are usually not a problem, some applications may have problems associated therewith. One example may be an array antenna having a plurality of ridge horns that are arranged along an E-plane direction (i.e., the oscillation direction of an electric field to concentrate). In such an array antenna, grating lobes will appear when the interval between a plurality of ridge horns arranged along the E-plane direction exceeds a wavelength λo in free space of an electromagnetic wave to be radiated or received. In many array antenna applications, grating lobes will cause deteriorations in performance. It is believed that grating lobes can be suppressed if electric field concentration at the ridge portion is alleviated. In antenna devices having a single ridge horn, too, it may be necessary to reduce electric field concentration at the ridge portion in some cases.

### SUMMARY

The present disclosure provides techniques for realizing ridge horns in each of which electric field concentration at a ridge portion is alleviated.

An antenna device according to an example embodiment of the present disclosure includes an electrical conductor including an electrically conductive surface and a slot that opens in the electrically conductive surface, a pair of electrically-conductive side walls on opposite sides of the slot and protruding from the electrically conductive surface, the pair of side walls flanking each other along a first direction, and each extending along a second direction that intersects the first direction, and a pair of electrically-conductive ridges each protruding from the electrically conductive surface and extending along the second direction and including an end surface, the respective end surfaces of the pair of ridges opposing each other via a gap that overlaps a central portion of the slot as viewed from a third direction that is perpendicular to the electrically conductive surface. A waveguide that is continuous with an external space is defined in a space inside the slot and between the end surfaces of the pair of ridges.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view showing a portion of an antenna device 10 according to an illustrative example embodiment of the present disclosure.

FIG. 2A is a perspective view showing the structure at the front side of a first conductive member 110.

FIG. 2B is a plan view showing the structure at the front side of the first conductive member 110.

FIG. 3A is an enlarged view showing a portion of partial arrays 11 and 12.

FIG. 3B is an enlarged view showing a portion of partial arrays 13 and 14.

FIG. 4 is a cross-sectional view taken along line A-A in FIG. 2B.

FIG. 5A is a diagram describing the shape of each slot 112 according to the present example embodiment.

FIG. 5B is a diagram showing another exemplary shape of each slot 112.

FIG. 5C is a diagram showing another exemplary shape of each slot 112.

FIG. 5D is a diagram showing another exemplary shape of each slot 112.

FIG. 6 is a diagram showing the structure at the front side of a second conductive member 120.

FIG. 7 is a diagram showing the structure at the front side of a third conductive member 130.

FIG. 8 is a perspective view schematically showing an exemplary construction of a waveguiding device.

FIG. 9A is a diagram schematically showing a cross-sectional construction of a waveguiding device 100 as taken in parallel to the XZ plane.

FIG. 9B is a diagram schematically showing another example of a cross-sectional construction of the waveguiding device 100 as taken in parallel to the XZ plane.

FIG. 10 is a perspective view schematically showing the waveguiding device 100, illustrated so that the spacing between a conductive member 110 and a conductive member 120 is exaggerated.

FIG. 11 is a diagram showing an exemplary range of dimension of each member in the structure shown in FIG. 9A.

FIG. 12A is a diagram showing another of a waveguiding device.

FIG. 12B is a diagram showing another of a waveguiding device.

FIG. 12C is a diagram showing another of a waveguiding device.

FIG. 12D is a diagram showing another of a waveguiding device.

FIG. 12E is a diagram showing another of a waveguiding device.

FIG. 12F is a diagram showing another of a waveguiding device.

FIG. 12G is a diagram showing another of a waveguiding device.

FIG. 13A is a diagram showing another of a waveguiding device.

FIG. 13B is a diagram showing another of a waveguiding device.

FIG. 14A is a diagram schematically showing an electromagnetic wave that propagates in a narrow space, i.e., a gap between the waveguide face 122a of the waveguide member 122 and the conductive surface 110b of the conductive member 110.

FIG. 14B is a diagram schematically showing a cross section of a hollow waveguide 730.

FIG. 14C is a cross-sectional view showing an implementation where two waveguide members 122 are provided on the conductive member 120.

FIG. 14D is a diagram schematically showing a cross section of a waveguiding device in which two hollow waveguides 730 are placed side-by-side.

FIG. 15A is a perspective view schematically showing a portion of the construction of an antenna device 200 utilizing a WRG structure.

FIG. 15B is a diagram schematically showing a portion of a cross-sectional construction as taken parallel to an XZ plane which passes through the centers of two adjacent slots 112 along the X direction of the antenna device 200.

FIG. 16 is a perspective view schematically showing a portion of the construction of an antenna device 200 that has a horn 114 for each slot 112 according to another example embodiment.

FIG. 17A is an upper plan view of the antenna device 200 shown in FIG. 16 as viewed from the Z direction.

FIG. 17B is a cross-sectional view taken along line C-C in FIG. 17A.

FIG. 17C is a diagram showing a planar layout of waveguide members 122U of a first waveguiding device 100a.

FIG. 17D is a diagram showing a planar layout of a waveguide member 122L of a second waveguiding device 100b.

### DETAILED DESCRIPTION

First, example embodiments of the present disclosure will be described in outline.

An antenna device according to an example embodiment of the present disclosure comprises: an electrically conductive member having an electrically conductive surface and a slot that opens in the electrically conductive surface; a pair of electrically-conductive side walls being disposed on opposite sides of the slot and protruding from the electrically conductive surface, the pair of side walls flanking each other along a first direction, and each extending along a second direction which intersects the first direction; and a pair of electrically-conductive ridges each protruding from the electrically conductive surface and extending along the second direction and having an end face, the respective end faces of the pair of ridges opposing each other via a gap that overlaps a central portion of the slot as viewed from a third direction which is perpendicular to the electrically conductive surface. A waveguide which is continuous with an external space is defined in a space existing inside the slot and between the end faces of the pair of ridges.

In the above construction, the slot, the pair of ridges, and the pair of side walls function as one antenna element. In the present specification, the side at which an electromagnetic wave is radiated or the side at which an electromagnetic wave arrives is referred to as “the front side”, and the opposite side thereof as “the rear side”. The aforementioned pair of ridges and pair of side walls are disposed on the front side of the electrically conductive member. During radiation of an electromagnetic wave, a radio-frequency signal wave is supplied to the slot from the rear side of the electrically conductive member. In response thereto, an electromagnetic wave propagates inside the slot (mainly the central portion) and the gap between the end faces of the pair of ridges, so as to be radiated into the external space. During reception, conversely, an electromagnetic wave arriving from the external space propagates in the gap between the end faces of the pair of ridges and the space inside the slot (mainly the central portion), so as to be transmitted to the rear side of the electrically conductive member. On the rear side of the electrically conductive member, another waveguide that is continuous with the waveguide in the slot may be constructed. This other waveguide may be connected to a microwave integrated circuit, for example. The microwave integrated circuit will function as at least one of a transmitter and a receiver.

With the above construction, existence of the pair of electrically-conductive side walls on opposite sides of the slot can alleviate electric field concentration occurring between the pair of ridges during transmission or during reception. The pair of side walls act in such a manner as to allow the distribution of field intensity of electromagnetic waves which are radiated or received by each slot to be expanded along the second direction. Alternatively, they provide an effect of dispersing positions at which the electric field intensity exhibits local maximums over a plurality of sites along the second direction. As a result, various influences of electric field concentration between the ridges can be suppressed. For example, in an antenna device (which hereinafter may also be referred to as an “array antenna”) that includes a plurality of aforementioned antenna elements (i.e., a plurality of sets each including a slot, a pair of ridges, and a pair of side walls), influences of grating lobes which would occur in the presence of a relatively wide interval between antenna elements can be alleviated.

As used herein, the term “slot” not only refers to a so-called “slot antenna”, but also encompasses any possible form within the broad semantic range of the plain word “slot”. Usually when the technical term “slot antenna” is used, it would be assumed that the depth of each slot is substantially negligibly small relative to the wavelength of the electromagnetic wave used. In the present disclosure, however, a “slot” is not limited to such a shallow slot. Even in the case where a given “slot” extends long along the depth direction, such that an electromagnetic wave which is fed from its lower end propagates in the slot until being radiated at its upper end, such a structure is still referred to as a “slot” in the present disclosure. Furthermore, an antenna having such a structure is to be regarded as a slot-based antenna.

One end of each of the pair of ridges may be structured so as to protrude into the slot as viewed from the third direction.

An inner surface of the slot may have two opposing faces which are spaced apart by a locally-diminished distance along the second direction. The end faces of the pair of ridges may be respectively continuous with the two faces, and an interval between the two faces and an interval between the end faces may increase toward the external space in a gradual or stepwise manner.

Each of the pair of ridges may have a top face intersecting the end face and extending along the second direction. The top face may include a section in which a height of the top face as measured from the electrically conductive surface decreases in a gradual or stepwise manner toward the end face. In order to realize this construction, each of the pair of ridges may have a protrusion at a distant position from the end face. Each ridge may have a sloped surface instead a protrusion.

Each of the pair of side walls may have a side face that is continuous with an inner surface of the slot so as to compose one integral surface therewith. The side face of each of the pair of side walls may be continuous with the inner surface of the slot via steps.

At least a portion of the gap between the end faces of the pair of ridges may be located between the pair of side walls. One end of each of the pair of ridges may be located between the pair of side walls. A height of the pair of side walls as measured from the electrically conductive surface may be greater than a height of the pair of ridges at the one end as measured from the electrically conductive surface.

As viewed from the third direction, the slot may have a shape that includes a lateral portion extending along the first direction, and a pair of vertical portions each being continuous with the lateral portion and extending along the second direction; the gap between the end faces of the pair of ridges may overlap the lateral portion of the slot; and the pair of side walls may be respectively adjacent to the pair of vertical portions.

The antenna device may further comprise a pair of electrically conductive walls respectively located, via a gap, on opposite and farther sides of the pair of side walls.

The electrically conductive member may have a plurality of slots, including the aforementioned slot. In that case, the antenna device may include: a plurality of pairs of electrically-conductive side walls, including the aforementioned pair of side walls; and a plurality of pairs of electrically-conductive ridges, including the aforementioned pair of ridges. Side walls in each pair among the plurality of pairs of side walls are disposed on opposite sides of a corresponding slot among the plurality of slots and protrude from the electrically conductive surface, the side walls flanking each other along the first direction, and each side wall extending along the second direction. Ridges in each pair among the plurality of pairs of ridges protrude from the electrically conductive surface, extend along the second direction, and each have an end face, the respective end faces of the pair of ridges opposing each other via a gap that overlaps a central portion of a corresponding slot among the plurality of slots as viewed from the third direction. A plurality of waveguides are defined inside the plurality of slots and in the gap between the end faces of the plurality of pairs of ridges.

In the above construction, an antenna device includes a plurality of antenna elements. Each antenna element includes a slot, a pair of ridges that are continuous with the slot, and a pair of side walls disposed on opposite sides of the slot. With this construction, an array antenna in which a plurality of antenna elements are arranged in e.g. a one-dimensional or two-dimensional array can be constructed.

The plurality of slots may include two or more slots flanking each other along the first direction. In this case, an array antenna can be constructed such that a plurality of antenna elements are arranged along the first direction.

The plurality of slots may include a first slot and a second slot flanking each other along the first direction. The plurality of pairs of side walls may include a first side wall pair located on opposite sides of the first slot and a second side wall pair located on opposite sides of the second slot. One side wall in the first side wall pair may be one side wall in the second side wall pair. Stated otherwise, one of the pair of side walls disposed on opposite sides of the first slot and one of the pair of side walls disposed on opposite sides of the second slot may each be a portion of a single wall-like structure. In this construction, the two side walls adjoining along the first direction are continuous, thereby creating a single wall-like structure. Such a construction is also to be deemed as if a pair of side walls respectively existed on opposite sides of each of two slots adjoining along the first direction.

Within the electrically conductive surface, a portion that is located between a root of one of the pair of ridges that is continuous with the first slot and a root of one of the pair of ridges that is continuous with the second slot may define a flat surface or a concave surface.

The plurality of slots may include two or more slots flanking each other along the second direction. In this case, an array antenna can be constructed such that a plurality of antenna elements are arranged along the second direction.

The plurality of slots may include a first slot and a third slot flanking each other along the second direction. One of the pair of ridges that is continuous with the first slot and one of the pair of ridges that is continuous with the third slot may each be a portion of a single ridge-shaped structure. In this construction, the two ridges flanking each other along the second direction are continuous, thereby creating a single ridge-shaped structure.

The plurality of slots may include: a first slot; a second slot which is distant from the first slot by a first interval along the first direction; and a third slot which is distant from the first slot by a second interval along the second direction, the second interval being greater than the first interval.

The antenna device may further comprise a pair of electrically conductive walls respectively located, via a gap, on opposite and farther sides of two or more side walls among the plurality of pairs of side walls that are disposed on opposite sides of the two or more slots flanking each other along the second direction.

The antenna device may further comprise a pair of electrically conductive walls respectively located, via a gap, on opposite sides of the entirety of the plurality of pairs of side walls.

When the electrically conductive member is a first electrically conductive member, and the electrically conductive surface is a first electrically conductive surface, the first electrically conductive member may have a second electrically conductive surface on an opposite side to the first electrically conductive surface. The antenna device may further comprise: a second electrically conductive member having a third electrically conductive surface opposing the second electrically conductive surface; a ridge-shaped waveguide member protruding from the third electrically conductive surface and extending along the second direction, the waveguide member having an electrically-conductive waveguide face opposing the second electrically conductive surface and the slot; and a plurality of electrically conductive rods disposed on opposite sides of the waveguide member and protruding from the third electrically conductive surface, each electrically conductive rod having a leading end opposing the second electrically conductive surface.

In the above construction, a waveguide is defined between the waveguide face of the waveguide member and the second electrically conductive surface. The plurality of electrically conductive rods function as an artificial magnetic conductor to suppress leakage of an electromagnetic wave propagating along the waveguide face. In the present specification, such a waveguide will be referred to as a waffle iron ridge waveguide (WRG) or a WRG waveguide. The WRG waveguide is connected to a waveguide that is created inside the slot and the end faces of each pair of ridges. The WRG waveguide may be connected to the microwave integrated circuit either directly or by way of another waveguide. The microwave integrated circuit will function as at least one of a transmitter and a receiver.

A radar system according to an example embodiment of the present disclosure comprises: any of the above antenna devices; at least one of a transmitter and a receiver that is connected to the antenna device; at least one of a D/A converter that is connected to the transmitter and an A/D converter that is connected to the receiver; and a signal processing circuit that is connected to the at least one of the D/A converter and the A/D converter. The at least one of the transmitter and the receiver comprises a microwave integrated circuit. The signal processing circuit performs at least one of direction-of-arrival estimation and distance estimation.

A communication system according to another example embodiment of the present disclosure comprises: any of the above antenna devices; at least one of a transmitter and a receiver that is connected to the antenna device; at least one of a D/A converter that is connected to the transmitter and an A/D converter that is connected to the receiver; and a signal processing circuit that is connected to the at least one of the D/A converter and the A/D converter. The signal processing circuit performs at least one of encoding of a digital signal and decoding of a digital signal.

Hereinafter, an example embodiment of the present disclosure will be described more specifically. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

Note that any structure appearing in a figure of the present application is shown in an orientation that is selected for ease of explanation, which in no way should limit its orientation when an example embodiment of the present disclosure is actually practiced. Moreover, the shape and size of a whole or a part of any structure that is shown in a figure should not limit its actual shape and size. Moreover, the constructions of the example embodiments describe below may be used in combinations to compose other example embodiments.

### Example Embodiment

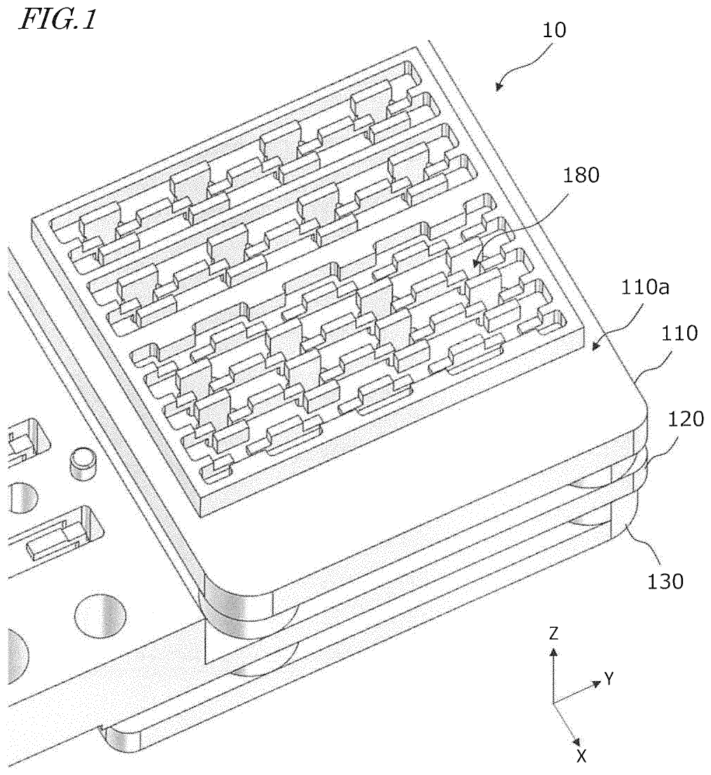

FIG. 1 is a perspective view showing a portion of an antenna device 10 according to an illustrative example embodiment of the present disclosure. The antenna device 10 is an array antenna including a plurality of antenna elements 180. In the following description, the antenna device 10 may also be referred to as an “array antenna 10”. The antenna device 10 includes a first electrically conductive member 110, a second electrically conductive member 120, and a third electrically conductive member 130. The first conductive member 110, the second conductive member 120, and the third conductive member 130 are layered in this order. The first conductive member 110 has a first electrically conductive surface 110a on the front side. On the first conductive member 110, a radiation section including the plurality of antenna elements 180 is provided.

FIG. 1 shows XYZ coordinates indicating X, Y and Z directions which are orthogonal to one another. Hereinafter, the construction according to the example embodiment of the present disclosure will be described by using this coordinate system. The +Z direction will be referred to as the “front side”, and the −Z direction will be referred to as the “rear side”. In the present example embodiment, the X direction corresponds to the “first direction”, the Y direction to the “second direction”; and the Z direction to the “third direction”.

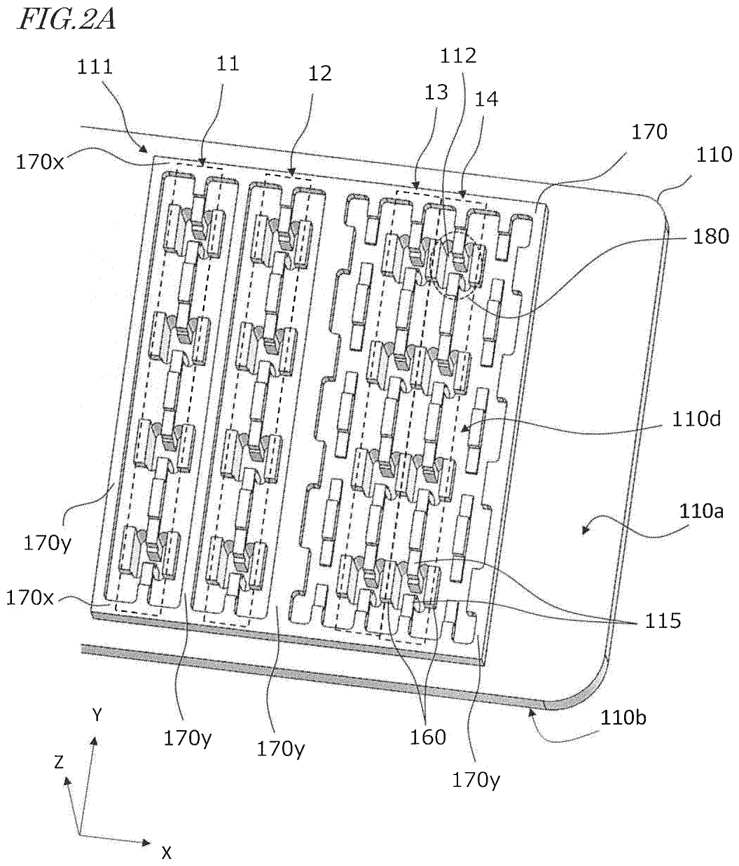

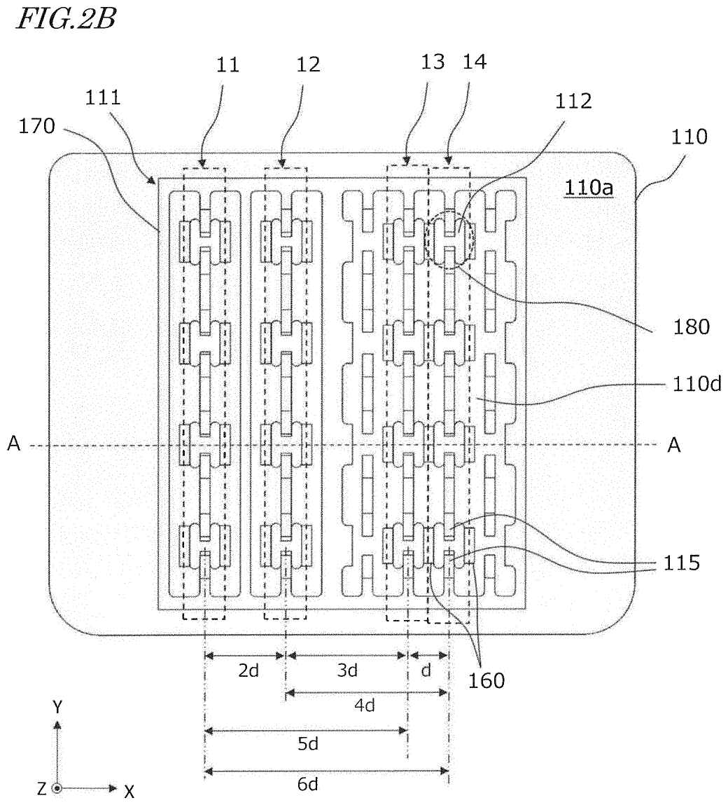

FIG. 2A is a perspective view showing the structure at the front side of the first conductive member 110. FIG. 2B is a plan view showing the structure at the front side of the first conductive member 110. As shown in the figures, the array antenna 10 includes the plurality of antenna elements 180 arranged in a two-dimensional array. The antenna elements 180, each of which is a ridge horn antenna, are arrayed along the X direction and along the Y direction.

The array antenna 10 includes four partial arrays 11 to 14 adjoining one another along the X direction. Each partial array includes four antenna elements 180 arranged along the Y direction. The partial arrays 11 to 14 are respectively fed by four waveguides that are provided on the rear side of the first conductive member 110. Among the four waveguides, a first waveguide feeds the partial array 11; a second waveguide feeds the partial array 12; a third waveguide feeds the partial array 13; and a fourth waveguide feeds the partial array 14. The four waveguides are provided between the first conductive member 110 and the second conductive member 120. Examples of the specific structure of these waveguides will be described later. Note that the number of partial arrays and the number of antenna element 180 included in each partial array can be adjusted in accordance with the application. Depending on the application, an antenna device that includes a single antenna element 180 may be constructed.

As shown in FIG. 2B, the partial arrays 11 to 14 according to the present example embodiment constitute a minimum redundancy array regarding the X direction (first direction). In other words, the partial arrays 11 to 14 are disposed so that the redundancy concerning the interval along the X direction between any two partial arrays (i.e., distance between their centers) among these will be minimum regarding the X direction. More specifically, given an interval d between the partial array 13 and the partial array 14, there is an interval of 2d between the partial array 11 and the partial array 12; there is an interval of 3d between the partial array 12 and the partial array 13; there is an interval of 4d between the partial array 12 and the partial array 14; there is an interval of 5d between the partial array 11 and the partial array 13; and there is an interval of 6d between the partial array 11 and the partial array 14. Thus, the interval between any two partial arrays chosen among the partial arrays 11 to 14 is always an integer multiple of the interval d, and there is minimum overlap of interval values. With such a minimum redundancy array construction, when the plurality of antenna elements 180 are used as reception antennas, it is easy to achieve a high spatial resolution even if there are only a few partial arrays.

Each antenna element 180 includes a slot 112, a pair of side walls 160, and a pair of ridges 115. The slot 112 is an aperture extending through the conductive member 110 and having a predetermined shape. In the present example embodiment illustrates a plurality of H-slots 112 being provided in the conductive member 110 as one example; however, the shape of each slot 112 may be arbitrary so long as it allows an electromagnetic wave to be radiated or captured. The pair of side walls 160 and the pair of ridges 115 protrude from the conductive member 110, and are electrically conductive at least at their surface.

The pair of side walls 160 flank each other along the X direction (first direction). The pair of ridges 115 flank each other along the Y direction (second direction). Along the X direction, the pair of side walls 160 are opposed to each other via a first gap. Along the Y direction, end faces of the pair of ridges 115 are opposed to each other via a second gap. The end face of each ridge 115 is a face that is substantially parallel to an XZ plane which is situated at an end of the ridge 115, and is continuous with the edge of a central portion of the corresponding slot 112. Ends of the pair of ridges 115 and the gap (second gap) therebetween are located between the pair of side walls 160. In other words, the first gap and the second gap partially overlap. Although the end face of each ridge 115 is illustrated to be planar in this example, the end face may be a curved surface, e.g., a convex surface or a concave surface.

In the present example embodiment, the pair of side walls 160 and the pair of ridges 115 are formed so as to be integral with the conductive member 110. In other words, the conductive member 110 and the plurality of pairs of side walls 160 and plurality of pairs of ridges 115 thereon are portions of a single-piece body. At least either one of the ridges 115 or the side walls 160 may be a member(s) that is different from the conductive member 110. In that case, such ridges 115 or side walls 160 are disposed on and supported by the conductive member 110. In that case, too, the ridges 115 and the side walls 160 are made of an electrically-conductive member.

As shown in FIG. 2A, the first conductive member 110 has a first conductive surface 110a on the front side and a second conductive surface 110b on the rear side. The first conductive member 110 has a plurality of slots 112 that open in the conductive surfaces 110a and 110b. As described above, each of the plurality of slots 112 has an associated pair of ridges 115 and pair of side walls 160, thus constituting a ridge horn antenna.

Each pair of side walls 160 and each pair of ridges 115 are structured so as to extend along the Y direction (second direction), and also to protrude from the first conductive surface 110a on the front side. The side walls 160 in each pair are located on opposite sides of the corresponding slot 112. The pair of side walls 160 are structured so as to flank each other along the X direction (first direction), each extending along the Y direction (second direction). Although the present example embodiment illustrates that the first direction and the second direction are orthogonal to each other, they may intersect each other at an angle which is not 90 degrees. The ridges 115 in each pair have respective end faces opposing each other via a gap that overlaps a central portion of the corresponding slot 112, as viewed from a Z direction (third direction) which is perpendicular to the conductive surface 110a. Each ridge 115 in the pair extends along the Y direction. As viewed from the third direction, one end of each ridge 115 in the pair protrudes into the slot 112. The inner surface of each slot 112 has, in the central portion, two opposing faces which are spaced apart by a locally-diminished distance along the Y direction. The end faces of the pair of ridges 115 are respectively continuous with the two faces. The interval between the two faces and the interval between the end faces of the pair of ridges 115 increase toward the external space. In the present example embodiment, the height of each side wall 160 as measured from the first conductive surface 110a is greater than the height of each ridge 115 as measured from the first conductive surface 110a. In the space inside the slot 112 and between the end faces of the pair of ridges 115, a waveguide which is continuous with the external space is defined. This waveguide extends along the Z direction, and is connected to another waveguide on the rear side of the first conductive member 110.

The opening of each slot 112 according to the present example embodiment has an H shape that includes a pair of vertical portions extending along the Y direction and a lateral portion being continuous with central portions of the pair of vertical portions and extending along the X direction (first direction). The pair of side walls 160 are disposed at positions adjacent to and extending along the vertical portions. The lateral portion is located between the end faces of the pair of ridges 115. In other words, the second gap is also continuous with the space inside the lateral portion of the slot 112. The first gap between the pair of side walls 160 is also continuous with the space inside the slot 112. Thus, in the present example embodiment, when viewed from the Z direction, the second gap between the end faces of the pair of ridges 115 overlaps the lateral portion of the slot 112, and the pair of side walls 160 are respectively adjacent to the pair of vertical portions.

The ridges 115 in the partial array 13 flank the ridges 115 in the partial array 14 along the X direction. Of those ridges 115 flanking each other along the X direction, their roots are connected to the bottom face 110d of the first conductive member 110. Of those side walls 160 flanking each other along the Y direction, their roots are also connected to the bottom face 110d of the first conductive member 110. The bottom face 110d is a portion of the first conductive surface 110a. Although the bottom face 110d is flat in this example, it may alternatively be a concave surface. As in this example, in the case where the plurality of slots 112 include a first slot and a second slot flanking each other along the X direction (first direction), the portion existing between the root of one of the pair of ridges that are continuous with the first slot and the root of one of the pair of ridges that are continuous with the second slot may be a flat surface or a concave surface. Although the bottom face 110d may also be a convex surface, in that case, the convex surface is to be designed so that its height is lower than a half of the height of either the side walls 160 or the surrounding wall 170. In other words, a space of a certain expanse is provided between the side walls 160 and the ridges 115. By providing such a space, each antenna element 180, as well as an antenna array including the antenna elements 180, can attain a broad bandwidth.

In the present example embodiment, the pair of side walls 160 of each antenna element 180 act in such a manner as to allow the distribution of field intensity of electromagnetic waves which are radiated or received by each antenna element 180 to be expanded along the Y direction. In the alternative, they may provide an effect of dispersing positions at which the electric field intensity exhibits local maximums over a plurality of sites along the Y direction. Antenna elements 180 having such characteristics are applicable to various applications, and are particularly useful when used for the array antenna 10 illustrated in the present example embodiment. For example, alleviation of influences of grating lobes and other favorable effects can be obtained.

In the example shown in FIG. 2B, the interval d between the partial array 13 and the partial array 14 may be set to e.g. λo/2. λo is the free space wavelength of an electromagnetic wave at the center frequency of an operation frequency band of the array antenna 10. In this case, the pitch between the partial array 13 and the partial array 14 along the X direction is λo/2. On the other hand, in each of the partial array 13 and the partial array 14, the pitch between any two adjacent antenna elements 180 adjoining along the Y direction is λo. In other words, the interval between any two antenna elements 180 in the two adjacent partial arrays 13 and 14 adjoining along the X direction is shorter than the interval between any two adjacent antenna elements 180 adjoining along the Y direction within the partial array 13 and the partial array 14. Thus, the plurality of slots 112 according to the present example embodiment includes: a first slot; a second slot which is distant from the first slot by a first interval along the X direction; and a third slot which is distant from the first slot by a second interval along the Y direction, the second interval being greater than the first interval.

As in the above example, in the case where the individual antenna elements 180 are disposed at an interval which is equal to or greater than the free space wavelength λo, intense grating lobes are likely to occur along the Y direction. However, in the array antenna 10 according to the present example embodiment, each antenna element 180 includes the pair of side walls 160 extending along the Y direction, whereby the positions at which the electric field intensity exhibits local maximums are dispersed across the Y direction, or electric field concentration is alleviated. As a result, the intensity of the grating lobes is also lowered.

In a scenario where a plurality of antenna elements 180 disposed along one waveguide are to be fed with electromagnetic waves, the interval between the antenna elements 180 is generally under a constraint which may make it less easy for them to be disposed at an interval smaller than λo. In that case, occurrence of grating lobes will be inevitable. However, when ridge horns including a pair of side walls 160 as in the present example embodiment are used as the antenna elements 180, the intensity of grating lobes can be lowered.

The array antenna 10 according to the present example embodiment includes the electrically-conductive surrounding wall 170, which extends around the plurality of antenna elements 180. The surrounding wall 170 protrudes from the first conductive surface 110a on the front side. As shown in FIG. 2A, the surrounding wall 170 includes four electrically conductive walls 170y extending along the Y direction and two conductive walls 170x extending along the X direction.

The four antenna elements 180 flanking along the Y direction, included in each of the partial arrays 11 and 12, are surrounded by the conductive walls 170x and 170y of the surrounding wall 170. On opposite and farther sides of the pair of side walls 160 of each antenna element 180 in the partial arrays 11 and 12, a pair of conductive walls 170y are located via gaps. The conductive wall 170y existing between the partial array 11 and the partial array 12 is shared as a portion of the surrounding wall by which the partial array 11 and the partial array 12 are surrounded.

The plurality of antenna elements 180 included in the partial arrays 13 and 14 are together surrounded by the surrounding wall 170. In the array antenna 10 according to the present example embodiment, directivity of an electromagnetic wave along the Y direction can be adjusted on the basis of the ridges 115 and the side walls 160. On the other hand, directivity of an electromagnetic wave along the X direction can be adjusted on the basis of not only the ridges 115 and the side walls 160 but also the surrounding wall 170. Providing the surrounding wall 170 can facilitate directivity adjustments along the X direction.

Each of the pair of ridges 115 has a top face which intersects its end face and extends along the Y direction. Steps are provided at the top face, i.e., an upper end face on the +Z side, of each ridge 115 according to the present example embodiment. Via the steps, the height of the top face of the ridge 115 from the conductive surface 110a becomes lower toward the center of the slot 112. In other words, the height of the top face from the conductive surface 110a is greater at positions farther away from the end face than positions closer to the end face. Instead of providing steps, a sloped surface may be adopted. Thus, the top face of each ridge 115 may include a section in which its height as measured from the conductive surface 110a decreases in a gradual or stepwise manner toward the end face.

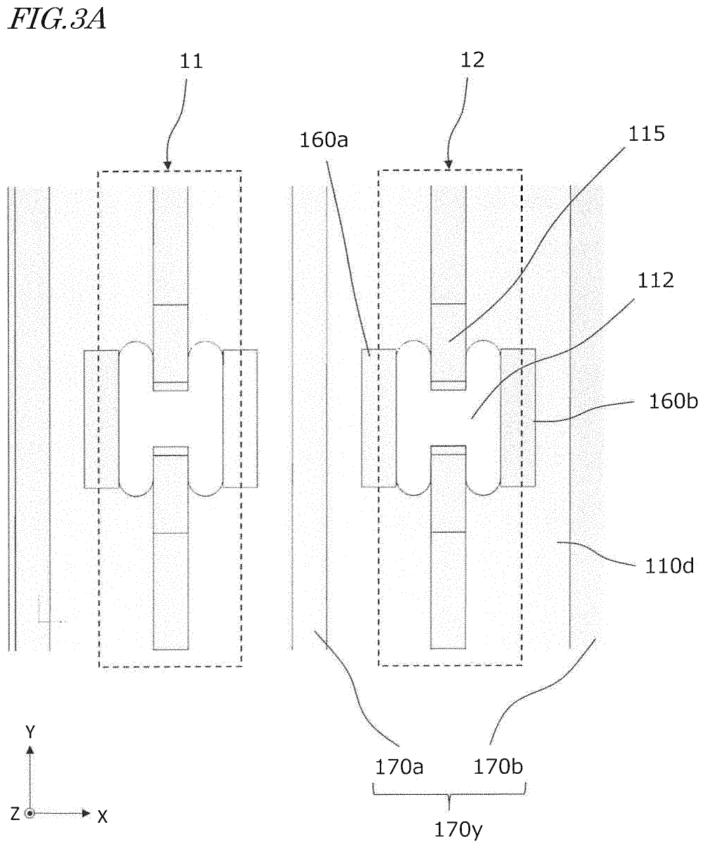

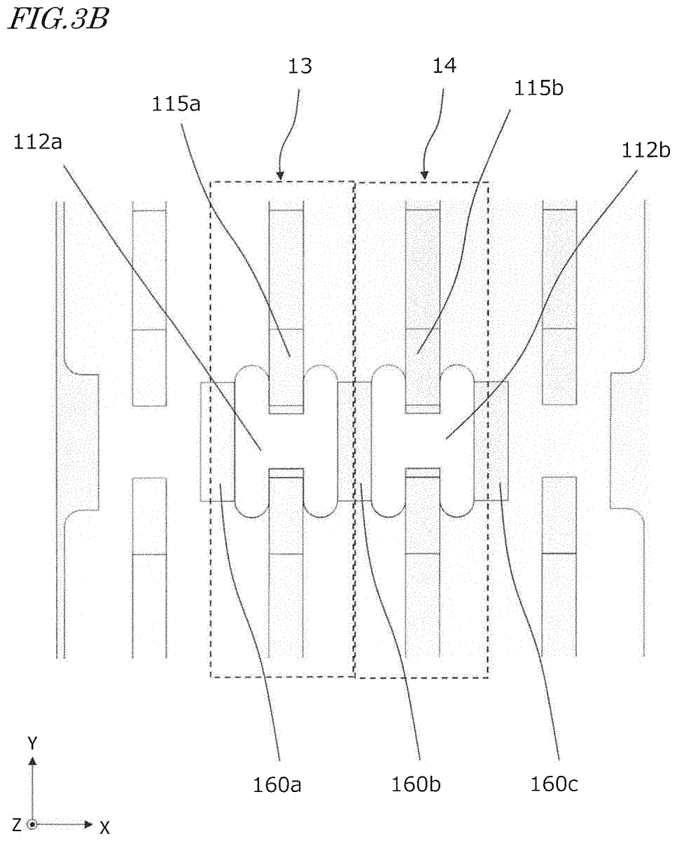

FIG. 3A is an enlarged view showing a portion of the partial arrays 11 and 12. FIG. 3A depicts an antenna element composing the partial array 11 and an antenna element composing the partial array 12. For ease of illustration, any portion protruding from the bottom face 110d is shaded differently from the bottom face 110d; that is, as viewed from the +Z to −Z direction, the lighter-shaded bottom face 110d is to be regarded as being located farther at the back than the face of any darker-shaded portion protruding from the bottom face 110d.

In FIG. 3A, the side wall and conductive wall (as a portion of the surrounding wall 170) located on the left side (−X side) of the right slot 112 will be respectively referred to as the “side wall 160a” and “conductive wall 170a”, whereas the side wall and conductive wall located on the right side (+X side) of that slot 112 will be respectively referred to as the “side wall 160b” and “conductive wall 170b”. In this example, the side wall 160a and the side wall 160b are equal in length.

Each vertical portion of the slot 112 is composed of both ends having curved edges and a linear portion extending between both ends. In this example, regarding the Y direction, the length of the linear portion of a vertical portion of the slot 112 is substantially equal to or greater than the length of the side wall 160a or 160b. Moreover, gaps exist between the side wall 160a and the conductive wall 170a and between the side wall 160b and the conductive wall 170b, where portions of the bottom face 110d extend. As in this example, the pair of conductive walls 170a and 170b may be respectively located, via a gap, on opposite and farther sides of the pair of side walls 160a and 160b of each antenna element 180.

FIG. 3B is an enlarged view showing a portion of the partial arrays 13 and 14. FIG. 3B depicts an antenna element composing the partial array 13 and an antenna element composing the partial array 14. As in FIG. 3A, for ease of illustration, any portion protruding from the bottom face 110d is shaded differently from the bottom face 110d. The bottom face 110d is shaded lighter, while the face of any portion protruding from the bottom face 110d is shaded darker.

In this example, no surrounding wall exists between two antenna elements flanking along the X direction. Moreover, among the three side walls 160a, 160b and 160c flanking along the X direction in the figure, the middle side wall 160b is shared by two antenna elements; that is, the side wall 160b functions as a side wall that is the closer to the slot 112b between the pair of side walls of the antenna element having the slot 112a, and also as a side wall that is the closer to the slot 112a between the pair of side walls of the antenna element having the slot 112b. Unlike in the example of FIG. 3A, the two antenna elements adjoin each other without any intervening conductive wall that is part of the surrounding wall. In order to adjust for the differing directivity due to this difference, the lengths of the side walls 160a through 160c are made shorter than the linear portion of the vertical portions of each slot 112.

FIG. 4 is a cross-sectional view taken along line A-A in FIG. 2B. As shown in the figure, each slot 112 is an aperture extending through the conductive member 110. The side walls 160 may be regarded as walls extending from the +Z side opening of each slot 112, as if an extension of the inner surface of the slot 112. The surrounding wall 170 is walls between the side walls 160 or outside of the side walls 160. Each of the pair of side walls 160 of each antenna element 180 according to the present example embodiment has a side face that is flush with the inner surface of the slot 112. Stated otherwise, each of the pair of side walls 160 has a side surface that is continuous with the inner surface of the slot 112 so as to compose one integral surface therewith. Each side wall 160 may be continuous with the inner surface of the slot 112 via a step(s).

In the present example embodiment, as shown in FIG. 2A and FIG. 2B, the surrounding wall 170 surrounds the plurality of antenna elements 180. However, it is not essential for the surrounding wall 170 to completely surround the plurality of antenna elements 180. Moreover, the surrounding wall 170 may be omitted if unnecessary.

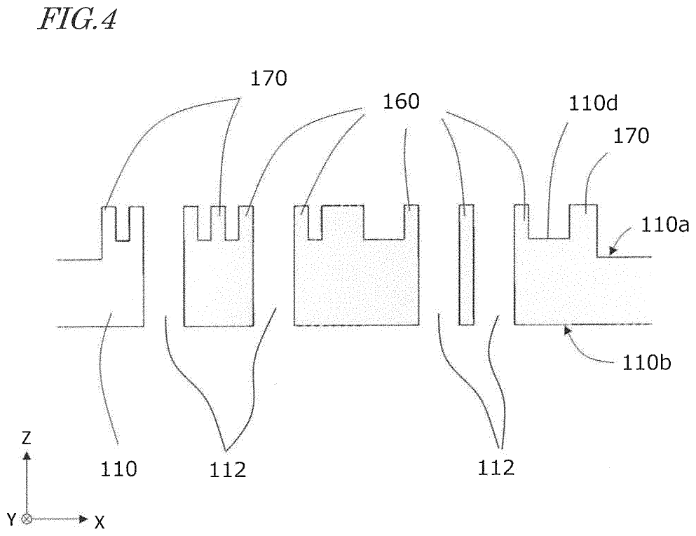

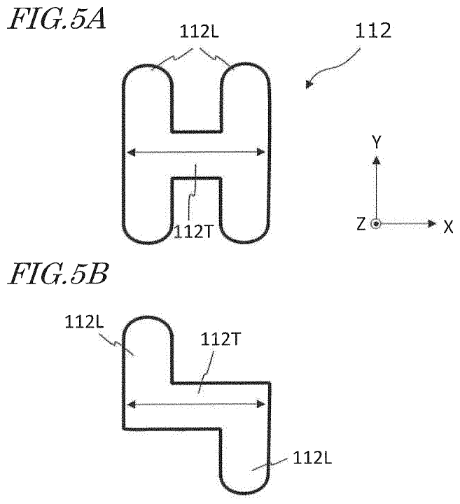

FIG. 5A is a diagram describing the shape of each slot 112 according to the present example embodiment. Each slot 112 in the present example embodiment is an H-slot having an H shape that includes a pair of vertical portions 112L and a lateral portion 112T that connects between the pair of vertical portions 112L. The lateral portion 112T is essentially perpendicular to the pair of vertical portions 112L, and connects between essentially the central portions of the pair of vertical portions 112L. The shape and size of each slot are determined so that higher-order resonance will not occur and that the impedance of the slot 112 will not be too small. In order to satisfy this condition, a dimension L, which is defined as twice the length from the center point (i.e., the center point of the lateral portion 112T) of the H shape to an end (either end of the vertical portions 112L) as taken along the lateral portion 112T and the vertical portions 112L, is set so that λo/2<L<λo, e.g., about λo/2. Based on this, the length (i.e., the length indicated by an arrow in the figure) of the lateral portion 112T can be made less than λo/2.

Without being limited to an H-slot as shown in FIG. 5A, each slot 112 may be a composite slot other than that of an H shape. A composite slot is meant to be a slot of a shape that includes a pair of vertical portions and a lateral portion which interconnects the pair of vertical portions. Besides H-slots in which a lateral portion connects between centers of a pair of vertical portions, other examples of composite slots include Z-slots, etc., in which a lateral portion connects between ends of a pair of vertical portions.

FIGS. 5B through 5D show examples of composite slots other than H-slots. Each slot includes a pair of vertical portions 112L and a lateral portion 112T. The direction that the lateral portion 112T in the center extends corresponds to the first direction. Adopting slots of any such shape allows the slot interval between lateral portions 112T along their longitudinal direction to be reduced.

FIG. 5B shows an example of a Z-slot which includes a lateral portion 112T and a pair of vertical portions 112L extending from opposite ends of the lateral portion 112T. The direction in which the pair of vertical portions 112L extend from the lateral portion 112T are substantially perpendicular to the lateral portion 112T, and are opposite to each other. One end of the lateral portion 112T is continuous with one end of one vertical portion 112L, whereas the other end of the lateral portion 112T is continuous with one end of the other vertical portion 112L. Since such a shape resembles the alphabetical letter “Z” or an inverted “Z”, it may be referred to as a “Z shape”. In this example, too, the length (i.e., the length indicated by an arrow in the figure) of the lateral portion 112T can be made e.g. less than λo/2.

FIGS. 5C and 5E each illustrate an exemplary slot having protrusions 112D. Slots of such shapes can also similarly function. In the example of FIG. 5C, in particular, a recess may be provided in the pair of side walls 160 adjoining the slot 112, the recess being continuous with the protrusions 112D of the slot 112.

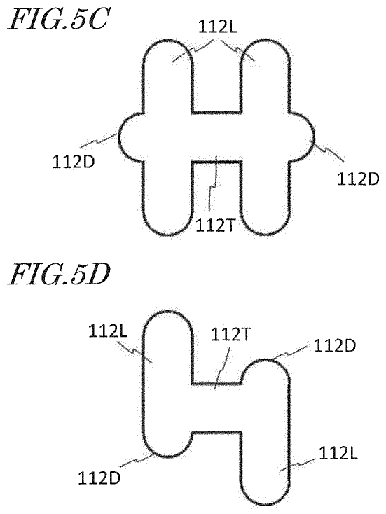

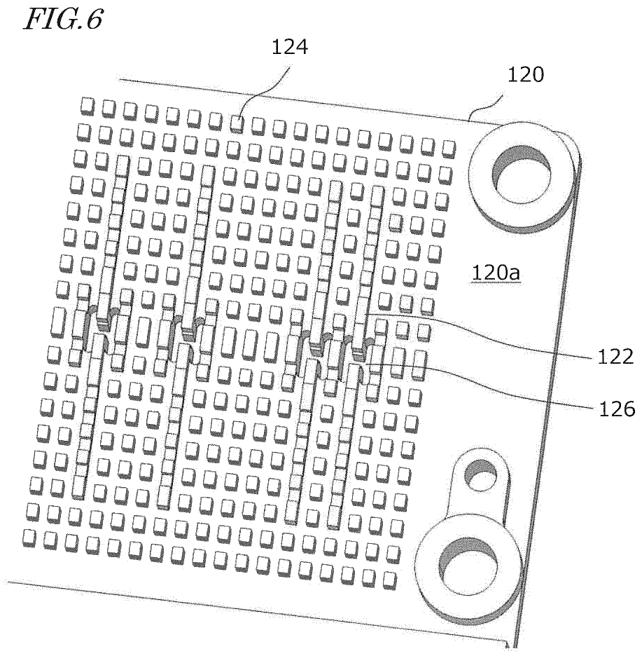

FIG. 6 is a diagram showing an example of the structure at the front side of the second conductive member 120. The second conductive member 120 has a third conductive surface 120a on the front side. The third conductive surface 120a is opposed to the second conductive surface 110b of the first conductive member 110. On the third conductive surface 120a, a plurality of waveguide members 122 and a plurality of electrically conductive rods 124 are disposed. Each waveguide member 122 has a ridge-shaped structure protruding from the third conductive surface 120a and extending along the Y direction (second direction). Each waveguide member 122 has an electrically-conductive waveguide face (top face) opposing the second conductive surface 110b and the plurality of slots 112. The plurality of conductive rods 124 are disposed on opposite sides of each waveguide member 122 and protrude from the third conductive surface 120a, each having a leading end opposing the second conductive surface 110b. The plurality of conductive rods 124 function as an artificial magnetic conductor which restrains an electromagnetic wave propagating along the waveguide member 122 from leaking outside. With such structure, a WRG waveguide as aforementioned is created along each waveguide member 122. A more detailed WRG waveguide construction will be described later.

The second conductive member 120 in this example has a plurality of throughholes 126 (ports) that open in the respective centers of the plurality of waveguide members 122. The throughholes 126 are connected to another waveguide that is on the rear side of the second conductive member 120.

Although the present example embodiment illustrates that the four throughholes 126 and four waveguide members 122 are provided on the second conductive member 120, their numbers would depend on the number of partial arrays on the first conductive member 110. When there is one partial array, the number of throughholes 126 and the number of waveguide members 122 may be one each.

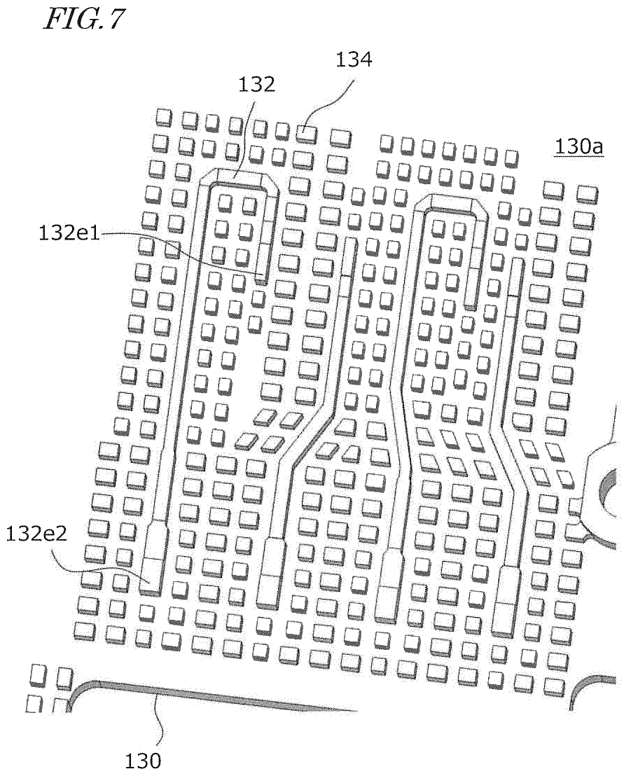

FIG. 7 is a diagram showing an example of the structure at the front side of the third conductive member 130. The third conductive member 130 has a third conductive surface 130a on the front side. The third conductive surface 130a is opposed to the conductive surface on the rear side of the second conductive member 120. A plurality of waveguide members 132 and a plurality of conductive rods 134 are also provided on the third conductive surface 130a. The plurality of conductive rods 134 function as an artificial magnetic conductor. WRG waveguides are created along the plurality of waveguide members 132. One end 132e1 of each waveguide member 132 is opposed to one throughhole 126 in the second conductive member 120. Another end 132e2 of each waveguide member 132 is connected to a microwave integrated circuit not shown. Radio-frequency signal waves that are generated by the microwave integrated circuit propagate along the waveguide members 132 so as to pass through the throughholes 126 in the second conductive member 120. The signal waves having passed through the throughholes 126 propagate along the waveguide members 122 on the second conductive member 120, and excite the plurality of slots 112 in the first conductive member 110. As a result of this, electromagnetic waves are radiated from the slots 112. During reception, through an opposite process, an electromagnetic wave that is captured through each slot 112 propagates along the waveguide member 122 and the waveguide member 132, so as to be received by the microwave integrated circuit.

The first conductive member 110, the second conductive member 120, the third conductive member 130, and any structure disposed thereon may be produced by forming a plating layer on the surface of an electrically insulative material, e.g., resin. In that case, each conductive member includes a dielectric member defining the shape of the conductive member and a plating layer of electrically conductive material that covers the surface of the dielectric member. As the electrically-conductive material composing the plating layer, a metal such as nickel or copper may be used. It is not necessary for the entirety of each electrically conductive member to have their shape defined by the dielectric member. The shape of a portion of each electrically conductive member may be directly defined by e.g. a metal member. Furthermore, instead of a plating layer, a layer of electrically conductive material may be formed by vapor deposition or the like. The second electrically conductive member may be produced by a metal machining of casting, forging, or the like. Each conductive member may be shaped by machining a metal plate. Each conductive member may be shaped by die-casting or the like.

Note that the waveguide structures shown in FIG. 6 and FIG. 7 are examples; the waveguide to be connected to each slot 112 in the first conductive member 110 may have various structures. For example, a different type of waveguide from the aforementioned WRG waveguide may be connected to each slot 112. Other types of waveguides would include hollow waveguides and microstrip lines, for example. These different types of waveguides may be combined to connect each slot 112 with the microwave integrated circuit.

The structures according to the above example embodiments and their variants are only illustrative, and admit of modifications as necessary. For example, the shapes, numbers, positions, and dimensions of slots, side walls, ridges, surrounding walls, throughholes, conductive rods, waveguide members, etc., on each conductive member may be altered depending on the application and the required characteristics.

### [Exemplary WRG Construction]

Next, an exemplary construction of a waffle iron ridge waveguide (WRG) which may be included in an antenna device according to an example embodiment of the present disclosure will be described in more detail. A WRG is a ridge waveguide that may be provided in a waffle iron structure functioning as an artificial magnetic conductor. Such a ridge waveguide is able to realize an antenna feeding network with low losses in the microwave or the millimeter wave band. Moreover, use of such a ridge waveguide allows antenna elements to be disposed with a high density. Hereinafter, an exemplary fundamental construction and operation of such a waveguide structure will be described.

An artificial magnetic conductor is a structure which artificially realizes the properties of a perfect magnetic conductor (PMC), which does not exist in nature. One property of a perfect magnetic conductor is that “a magnetic field on its surface has zero tangential component”. This property is the opposite of the property of a perfect electric conductor (PEC), i.e., “an electric field on its surface has zero tangential component”. Although no perfect magnetic conductor exists in nature, it can be embodied by an artificial structure, e.g., an array of a plurality of electrically conductive rods. An artificial magnetic conductor functions as a perfect magnetic conductor in a specific frequency band which is defined by its structure. An artificial magnetic conductor restrains or prevents an electromagnetic wave of any frequency that is contained in the specific frequency band (propagation-restricted band) from propagating along the surface of the artificial magnetic conductor. For this reason, the surface of an artificial magnetic conductor may be referred to as a high impedance surface.

For example, a plurality of electrically conductive rods that are arranged along row and column directions may constitute an artificial magnetic conductor. Such rods may be referred to posts or pins. Each of these waveguiding devices, as a whole, includes a pair of opposing electrically conductive plates. One of the electrically conductive plates has a ridge that protrudes toward the other electrically conductive plate, and an artificial magnetic conductor that are located on both sides of the ridge. Via a gap, an upper face (which is an electrically-conductive face) of the ridge is opposed to the electrically conductive surface of the other electrically conductive plate. An electromagnetic wave (signal wave) of a wavelength which is contained in the propagation stop band of the artificial magnetic conductor propagates along the ridge, in the space (gap) between this conductive surface and the upper face of the ridge.

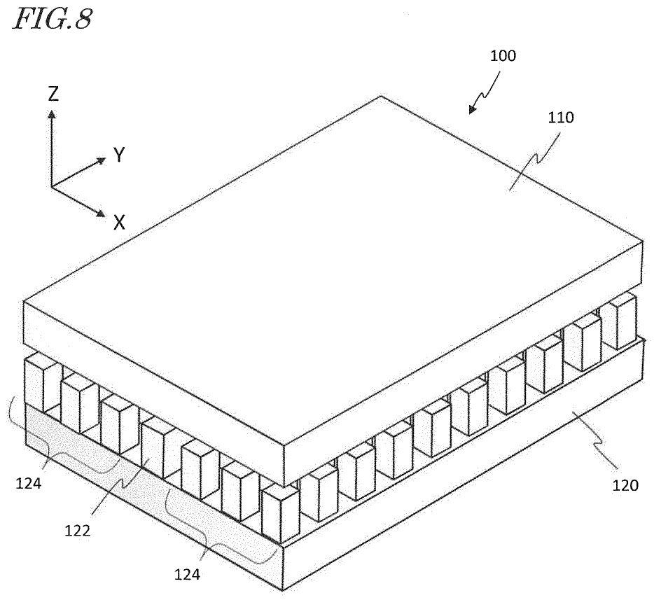

FIG. 8 is a perspective view showing a non-limiting example of a fundamental construction of such a waveguiding device. The waveguiding device 100 shown in the figure includes a plate shape (plate-like) electrically conductive members 110 and 120, which are in opposing and parallel positions to each other. A plurality of electrically conductive rods 124 are arrayed on the conductive member 120.

FIG. 9A is a diagram schematically showing a cross-sectional construction of the waveguiding device 100 as taken parallel to the XZ plane. As shown in FIG. 9A, the conductive member 110 has an electrically conductive surface 110b on the side facing the conductive member 120. The conductive surface 110b has a two-dimensional expanse along a plane which is orthogonal to the axial direction (i.e., the Z direction) of the conductive rods 124 (i.e., a plane which is parallel to the XY plane). Although the conductive surface 110b is shown to be a smooth plane in this example, the conductive surface 110b does not need to be a plane, as will be described later.

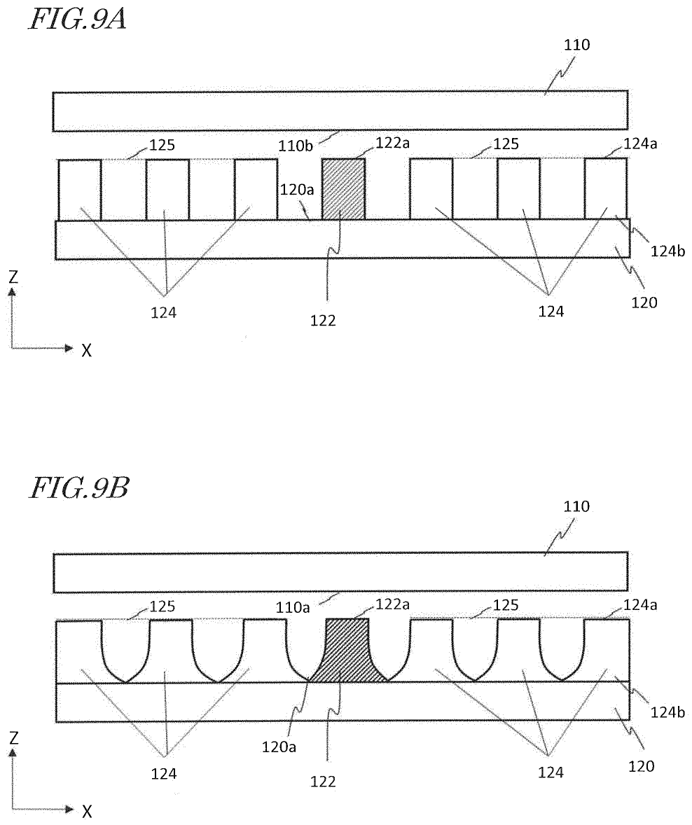

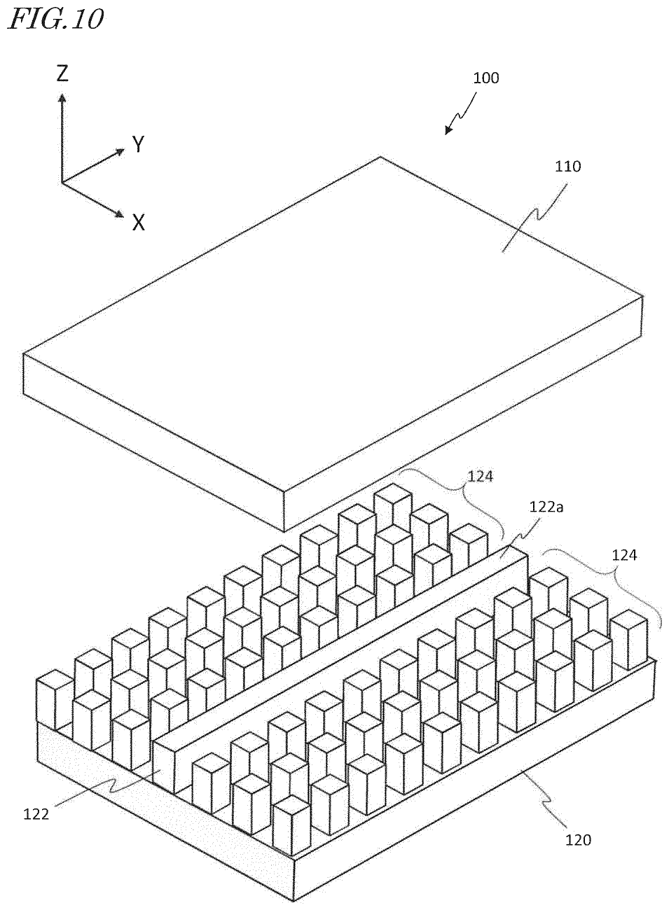

FIG. 10 is a perspective view schematically showing the waveguiding device 100, illustrated so that the spacing between the conductive member 110 and the conductive member 120 is exaggerated for ease of understanding. In an actual waveguiding device 100, as shown in FIG. 8 and FIG. 9A, the spacing between the conductive member 110 and the conductive member 120 is narrow, with the conductive member 110 covering over all of the conductive rods 124 on the conductive member 120.

FIG. 8 to FIG. 10 only show portions of the waveguiding device 100. The conductive members 110 and 120, the waveguide member 122, and the plurality of conductive rods 124 actually extend to outside of the portions illustrated in the figures. At an end of the waveguide member 122, as described above, a choke structure for preventing electromagnetic waves from leaking into the external space is provided. The choke structure may include a row of conductive rods that are adjacent to the end of the waveguide member 122, for example.

See FIG. 9A again. The plurality of conductive rods 124 arrayed on the conductive member 120 each have a leading end 124a opposing the conductive surface 110b. In the example shown in the figure, the leading ends 124a of the plurality of conductive rods 124 are on the same plane or on substantially the same plane. This plane defines the surface 125 of an artificial magnetic conductor. Each conductive rod 124 does not need to be entirely electrically conductive, so long as it includes an electrically conductive layer which extends at least along the upper face and the side faces of the rod-like structure. This electrically conductive layer may be located on the surface layer of the rod-like structure; alternatively, the surface layer may be composed of insulation coating or a resin layer, with no electrically conductive layer being present on the surface of the rod-like structure. Moreover, each conductive member 120 does not need to be entirely electrically conductive, so long as it can support the plurality of conductive rods 124 to constitute an artificial magnetic conductor. Of the surfaces of the conductive member 120, a face carrying the plurality of conductive rods 124 may be electrically conductive, such that the electrical conductor electrically interconnects the surfaces of adjacent ones of the plurality of conductive rods 124. The electrically conductive layer of the conductive member 120 may be covered with insulation coating or a resin layer. In other words, the entire combination of the conductive member 120 and the plurality of conductive rods 124 may at least include an electrically conductive layer with rises and falls opposing the conductive surface 110b of the conductive member 110.

On the conductive member 120, a ridge-like waveguide member 122 is provided among the plurality of conductive rods 124. More specifically, stretches of an artificial magnetic conductor are present on both sides of the waveguide member 122, such that the waveguide member 122 is sandwiched between the stretches of artificial magnetic conductor on both sides. As can be seen from FIG. 10, the waveguide member 122 in this example is supported on the conductive member 120, and extends linearly along the Y direction. In the example shown in the figure, the waveguide member 122 has the same height and width as those of the conductive rods 124. As will be described later, however, the height and width of the waveguide member 122 may have respectively different values from those of the conductive rod 124. Unlike the conductive rods 124, the waveguide member 122 extends along a direction (which in this example is the Y direction) in which to guide electromagnetic waves along the conductive surface 110b. Similarly, the waveguide member 122 does not need to be entirely electrically conductive, but may at least include an electrically conductive waveguide face 122a opposing the conductive surface 110b of the conductive member 110. The conductive member 120, the plurality of conductive rods 124, and the waveguide member 122 may be portions of a continuous single-piece body. Furthermore, the conductive member 110 may also be a portion of such a single-piece body.

On both sides of the waveguide member 122, the space between the surface 125 of each stretch of artificial magnetic conductor and the conductive surface 110b of the conductive member 110 does not allow an electromagnetic wave of any frequency that is within a specific frequency band to propagate. This frequency band is called a “prohibited band”. The artificial magnetic conductor is designed so that the frequency of an electromagnetic wave (signal wave) to propagate in the waveguiding device 100 (which may hereinafter be referred to as the “operating frequency”) is contained in the prohibited band. The prohibited band may be adjusted based on the following: the height of the conductive rods 124, i.e., the depth of each groove formed between adjacent conductive rods 124; the diameter of each conductive rod 124; the interval between conductive rods 124; and the size of the gap between the leading end 124a and the conductive surface 110b of each conductive rod 124.

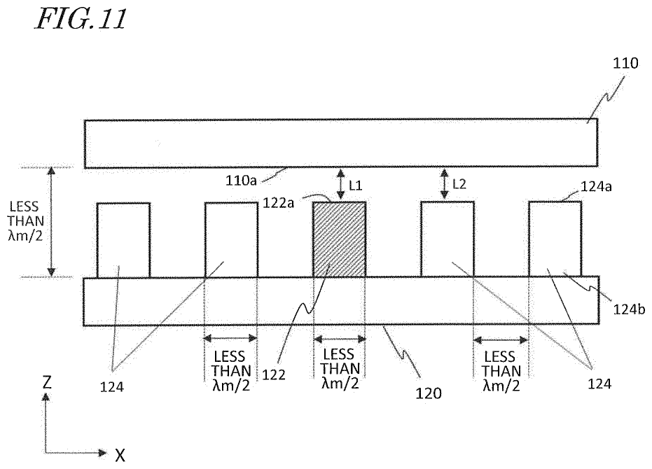

Next, with reference to FIG. 11, the dimensions, shape, positioning, and the like of each member will be described.

FIG. 11 is a diagram showing an exemplary range of dimension of each member in the structure shown in FIG. 9A. The waveguiding device is used for at least one of transmission and reception of electromagnetic waves of a predetermined band (referred to as the “operating frequency band”). In the present specification, λo denotes a representative value of wavelengths in free space (e.g., a central wavelength corresponding to a center frequency in the operating frequency band) of an electromagnetic wave (signal wave) propagating in a waveguide extending between the conductive surface 110b of the conductive member 110 and the waveguide face 122a of the waveguide member 122. Moreover, λm denotes a wavelength, in free space, of an electromagnetic wave of the highest frequency in the operating frequency band. The end of each conductive rod 124 that is in contact with the conductive member 120 is referred to as the “root”. As shown in FIG. 11, each conductive rod 124 has the leading end 124a and the root 124b. Examples of dimensions, shapes, positioning, and the like of the respective members are as follows.

### (1) Width of the Conductive Rod

The width (i.e., the size along the X direction and the Y direction) of the conductive rod 124 may be set to less than λm/2. Within this range, resonance of the lowest order can be prevented from occurring along the X direction and the Y direction. Since resonance may possibly occur not only in the X and Y directions but also in any diagonal direction in an X-Y cross section, the diagonal length of an X-Y cross section of the conductive rod 124 is also preferably less than λm/2. The lower limit values for the rod width and diagonal length will conform to the minimum lengths that are producible under the given manufacturing method, but is not particularly limited.

### (2) Distance From the Root of the Conductive Rod to the Conductive Surface of the Conductive Member 110

The distance from the root 124b of each conductive rod 124 to the conductive surface 110b of the conductive member 110 may be longer than the height of the conductive rods 124, while also being less than λm/2. When the distance is λm/2 or more, resonance may occur between the root 124b of each conductive rod 124 and the conductive surface 110b, thus reducing the effect of signal wave containment.

The distance from the root 124b of each conductive rod 124 to the conductive surface 110b of the conductive member 110 corresponds to the spacing between the conductive member 110 and the conductive member 120. For example, when a signal wave of 76.5±0.5 GHz (which belongs to the millimeter band or the extremely high frequency band) propagates in the waveguide, the wavelength of the signal wave is in the range from 3.8934 mm to 3.9446 mm. Therefore, λm equals 3.8934 mm in this case, so that the spacing between the conductive member 110 and the conductive member 120 may be designed to be less than a half of 3.8934 mm. So long as the conductive member 110 and the conductive member 120 realize such a narrow spacing while being disposed opposite from each other, the conductive member 110 and the conductive member 120 do not need to be strictly parallel. Moreover, when the spacing between the conductive member 110 and the conductive member 120 is less than λm/2, a whole or a part of the conductive member 110 and/or the conductive member 120 may be shaped as a curved surface. On the other hand, the conductive members 110 and 120 each have a planar shape (i.e., the shape of their region as perpendicularly projected onto the XY plane) and a planar size (i.e., the size of their region as perpendicularly projected onto the XY plane) which may be arbitrarily designed depending on the purpose.

In the example shown in FIG. 9A, the conductive surface 120a is illustrated as a plane; however, example embodiments of the present disclosure are not limited thereto. For example, as shown in FIG. 9B, the conductive surface 120a may be the bottom parts of faces each of which has a cross section similar to a U-shape or a V-shape. The conductive surface 120a will have such a structure when each conductive rod 124 or the waveguide member 122 is shaped with a width which increases toward the root. Even with such a structure, the device shown in FIG. 9B can function as the waveguiding device according to an example embodiment of the present disclosure so long as the distance between the conductive surface 110b and the conductive surface 120a is less than a half of the wavelength λm.

### (3) Distance L2 From the Leading End of the Conductive Rod to the Conductive Surface

The distance L2 from the leading end 124a of each conductive rod 124 to the conductive surface 110b is set to less than λm/2. When the distance is λm/2 or more, a propagation mode where electromagnetic waves reciprocate between the leading end 124a of each conductive rod 124 and the conductive surface 110b may occur, thus no longer being able to contain an electromagnetic wave. Note that, among the plurality of conductive rods 124, at least those which are adjacent to the waveguide member 122 do not have their leading ends in electrical contact with the conductive surface 110b. As used herein, the leading end of a conductive rod not being in electrical contact with the conductive surface means either of the following states: there being an air gap between the leading end and the conductive surface; or the leading end of the conductive rod and the conductive surface adjoining each other via an insulating layer which may exist in the leading end of the conductive rod or in the conductive surface.

### (4) Arrangement and Shape of Conductive Rods

The interspace between two adjacent conductive rods 124 among the plurality of conductive rods 124 has a width of less than λm/2, for example. The width of the interspace between any two adjacent conductive rods 124 is defined by the shortest distance from the surface (side face) of one of the two conductive rods 124 to the surface (side face) of the other. This width of the interspace between rods is to be determined so that resonance of the lowest order will not occur in the regions between rods. The conditions under which resonance will occur are determined based by a combination of: the height of the conductive rods 124; the distance between any two adjacent conductive rods; and the capacitance of the air gap between the leading end 124a of each conductive rod 124 and the conductive surface 110b. Therefore, the width of the interspace between rods may be appropriately determined depending on other design parameters. Although there is no clear lower limit to the width of the interspace between rods, for manufacturing ease, it may be e.g. λm/16 or more when an electromagnetic wave in the extremely high frequency range is to be propagated. Note that the interspace does not need to have a constant width. So long as it remains less than λm/2, the interspace between conductive rods 124 may vary.

The arrangement of the plurality of conductive rods 124 is not limited to the illustrated example, so long as it exhibits a function of an artificial magnetic conductor. The plurality of conductive rods 124 do not need to be arranged in orthogonal rows and columns; the rows and columns may be intersecting at angles other than 90 degrees. The plurality of conductive rods 124 do not need to form a linear array along rows or columns, but may be in a dispersed arrangement which does not present any straight-forward regularity. The conductive rods 124 may also vary in shape and size depending on the position on the conductive member 120.

The surface 125 of the artificial magnetic conductor that are constituted by the leading ends 124a of the plurality of conductive rods 124 does not need to be a strict plane, but may be a plane with minute rises and falls, or even a curved surface. In other words, the conductive rods 124 do not need to be of uniform height, but rather the conductive rods 124 may be diverse so long as the array of conductive rods 124 is able to function as an artificial magnetic conductor.

Each conductive rod 124 does not need to have a prismatic shape as shown in the figure, but may have a cylindrical shape, for example. Furthermore, each conductive rod 124 does not need to have a simple columnar shape. The artificial magnetic conductor may also be realized by any structure other than an array of conductive rods 124, and various artificial magnetic conductors are applicable to the waveguiding device of the present disclosure. Note that, when the leading end 124a of each conductive rod 124 has a prismatic shape, its diagonal length is preferably less than λm/2. When the leading end 124a of each conductive rod 124 is shaped as an ellipse, the length of its major axis is preferably less than λm/2. Even when the leading end 124a has any other shape, the dimension across it is preferably less than λm/2 even at the longest position.

The height of each conductive rod 124 (in particular, those conductive rods 124 which are adjacent to the waveguide member 122), i.e., the length from the root 124b to the leading end 124a, may be set to a value which is shorter than the distance (i.e., less than λm/2) between the conductive surface 110b and the conductive surface 120a, e.g., λo/4.

### (5) Width of the Waveguide Face

The width of the waveguide face 122a of the waveguide member 122, i.e., the size of the waveguide face 122a along a direction which is orthogonal to the direction that the waveguide member 122 extends, may be set to less than λm/2 (e.g. λo/8). If the width of the waveguide face 122a is λm/2 or more, resonance will occur along the width direction, which will prevent any WRG from operating as a simple transmission line.

### (6) Height of the Waveguide Member

The height (i.e., the size along the Z direction in the example shown in the figure) of the waveguide member 122 is set to less than λm/2. The reason is that, if the distance is λm/2 or more, the distance between the root 124b of each conductive rod 124 and the conductive surface 110b will be λm/2 or more.

### (7) Distance L1 Between the Waveguide Face and the Conductive Surface

The distance L1 between the waveguide face 122a of the waveguide member 122 and the conductive surface 110b is set to less than λm/2. If the distance is λm/2 or more, resonance will occur between the waveguide face 122a and the conductive surface 110b, which will prevent functionality as a waveguide. In one example, the distance L1 is λm/4 or less. In order to ensure manufacturing ease, when an electromagnetic wave in the extremely high frequency range is to propagate, the distance L1 is preferably λm/16 or more, for example.

The lower limit of the distance L1 between the conductive surface 110b and the waveguide face 122a and the lower limit of the distance L2 between the conductive surface 110b and the leading end 124a of each conductive rod 124 depends on the machining precision, and also on the precision when assembling the two upper/lower conductive members 110 and 120 so as to be apart by a constant distance. When a pressing technique or an injection technique is used, the practical lower limit of the aforementioned distance is about 50 micrometers (μm). In the case of using MEMS (Micro-Electro-Mechanical System) technology to make a product in e.g. the terahertz range, the lower limit of the aforementioned distance is about 2 to about 3 μm.

Next, variants of waveguide structures including the waveguide member 122, the conductive members 110 and 120, and the plurality of conductive rods 124 will be described. The following variants are applicable to the WRG structure in any place in example embodiments of the present disclosure.

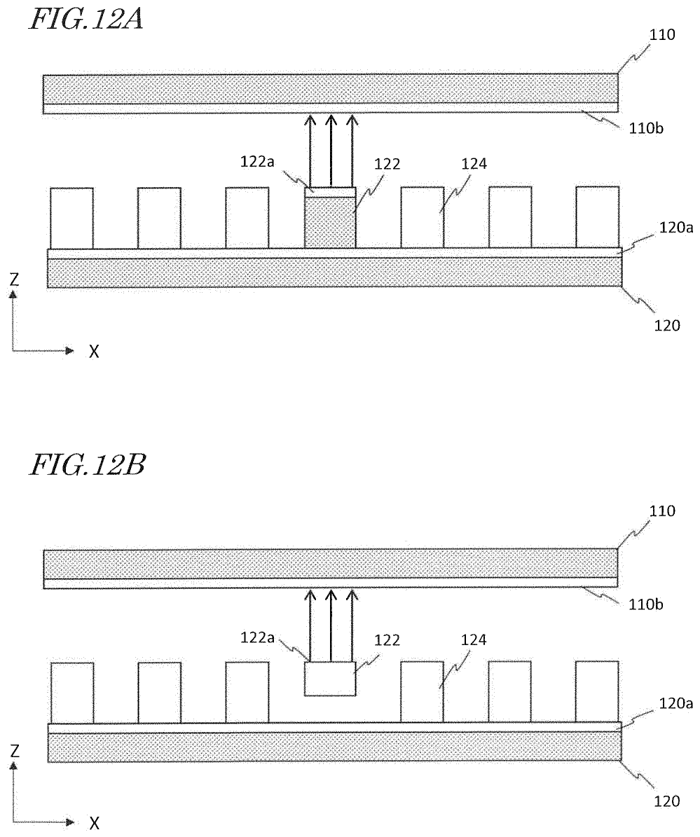

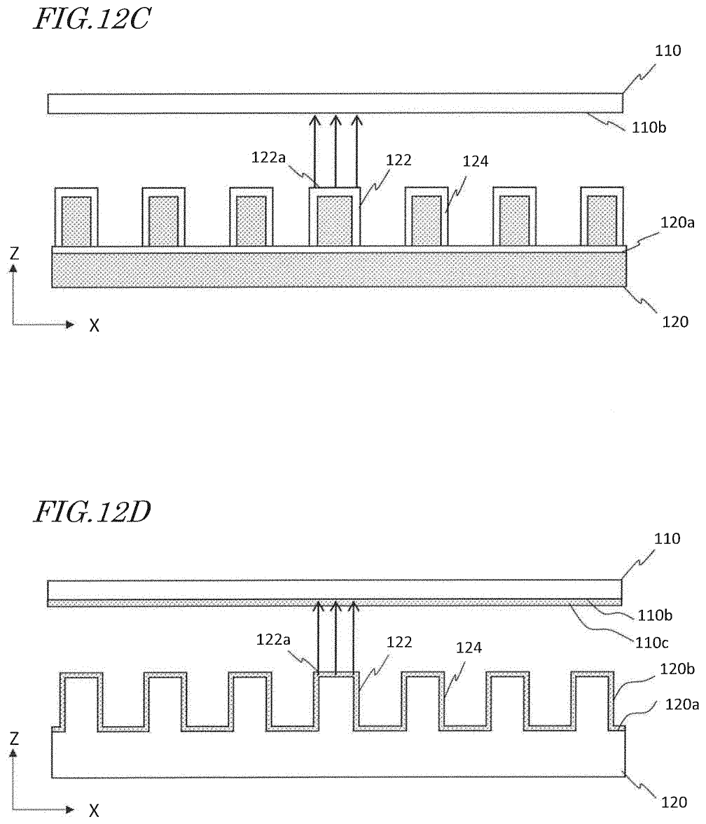

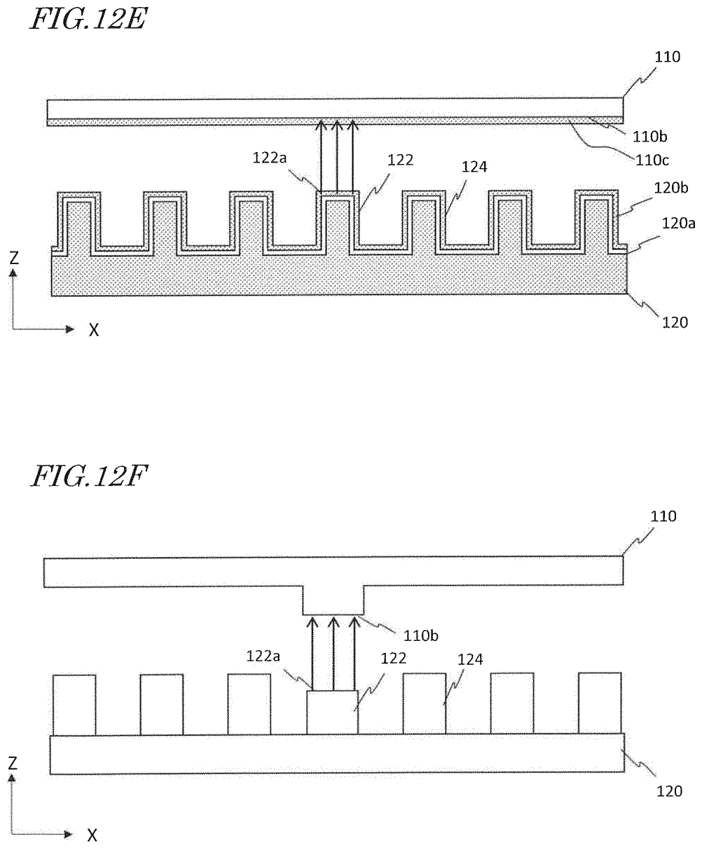

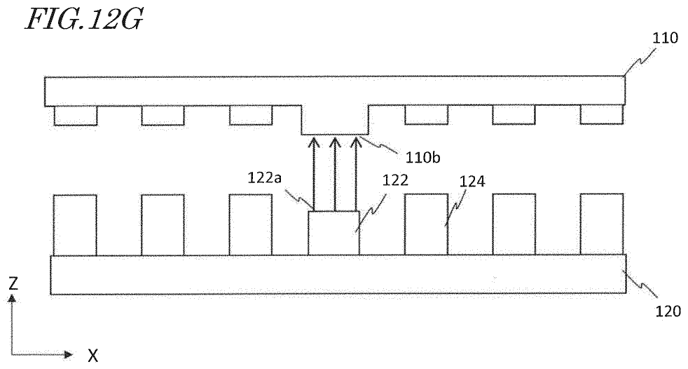

FIG. 12A is a cross-sectional view showing an exemplary structure in which only the waveguide face 122a, defining an upper face of the waveguide member 122, is electrically conductive, while any portion of the waveguide member 122 other than the waveguide face 122a is not electrically conductive. Both of the conductive members 110 and 120 alike are only electrically conductive at their surface that has the waveguide member 122 provided thereon (i.e., the conductive surface 110b, 120a), while not being electrically conductive in any other portions. Thus, each of the waveguide member 122, the conductive member 110, and the conductive member 120 does not need to be electrically conductive.

FIG. 12B is a diagram showing a variant in which the waveguide member 122 is not formed on the conductive member 120. In this example, the waveguide member 122 is fixed to a supporting member (e.g., the inner wall of the housing) that supports the conductive members 110 and 120. A gap exists between the waveguide member 122 and the conductive member 120. Thus, the waveguide member 122 does not need to be connected to the conductive member 120.

FIG. 12C is a diagram showing an exemplary structure where the conductive member 120, the waveguide member 122, and each of the plurality of conductive rods 124 are composed of a dielectric surface that is coated with an electrically conductive material such as a metal. The conductive member 120, the waveguide member 122, and the plurality of conductive rods 124 are connected to one another via the electrical conductor. On the other hand, the conductive member 110 is made of an electrically conductive material such as a metal.

FIG. 12D and FIG. 12E are diagrams each showing an exemplary structure in which dielectric layers 110c and 120b are respectively provided on the outermost surfaces of conductive members 110 and 120, a waveguide member 122, and conductive rods 124. FIG. 12D shows an exemplary structure in which the surface of metal conductive members, which are electrical conductors, are covered with a dielectric layer. FIG. 12E shows an example where the conductive member 120 is structured so that the surface of members which are composed of a dielectric, e.g., resin, is covered with an electrical conductor such as a metal, this metal layer being further coated with a dielectric layer. The dielectric layer that covers the metal surface may be a coating of resin or the like, or an oxide film of passivation coating or the like which is generated as the metal becomes oxidized.

The dielectric layer on the outermost surface will allow losses to be increased in the electromagnetic wave propagating through the WRG waveguide, but is able to protect the conductive surfaces 110b and 120a (which are electrically conductive) from corrosion. It also prevents influences of a DC voltage, or an AC voltage of such a low frequency that it is not capable of propagation on certain WRG waveguides.

FIG. 12F is a diagram showing an example where the height of the waveguide member 122 is lower than the height of the conductive rods 124, and the portion of the conductive surface 110b of the conductive member 110 that is opposed to the waveguide face 122a protrudes toward the waveguide member 122. Even such a structure will operate in a similar manner to the above-described example embodiment, so long as the ranges of dimensions depicted in FIG. 11 are satisfied.

FIG. 12G is a diagram showing an example where, further in the structure of FIG. 12F, portions of the conductive surface 110b that are opposed to the conductive rods 124 protrude toward the conductive rods 124. Even such a structure will operate in a similar manner to the above-described example embodiment, so long as the ranges of dimensions depicted in FIG. 11 are satisfied. Instead of a structure in which the conductive surface 110b partially protrudes, a structure in which the conductive surface 110b is partially dented may be adopted.

FIG. 13A is a diagram showing an example where a conductive surface 110b of the conductive member 110 is shaped as a curved surface. FIG. 13B is a diagram showing an example where also a conductive surface 120a of the conductive member 120 is shaped as a curved surface. As demonstrated by these examples, the conductive surfaces 110b and 120a may not be shaped as planes, but may be shaped as curved surfaces. A conductive member having a conductive surface which is a curved surface is also qualifies as a conductive member having a “plate shape”.

In the waveguiding device 100 of the above-described construction, a signal wave of the operating frequency is unable to propagate in the space between the surface 125 of the artificial magnetic conductor and the conductive surface 110b of the conductive member 110, but propagates in the space between the waveguide face 122a of the waveguide member 122 and the conductive surface 110b of the conductive member 110. Unlike in a hollow waveguide, the width of the waveguide member 122 in such a waveguide structure does not need to be equal to or greater than a half of the wavelength of the electromagnetic wave to propagate. Moreover, the conductive member 110 and the conductive member 120 do not need to be electrically interconnected by a metal wall that extends along the thickness direction (i.e., in parallel to the YZ plane).

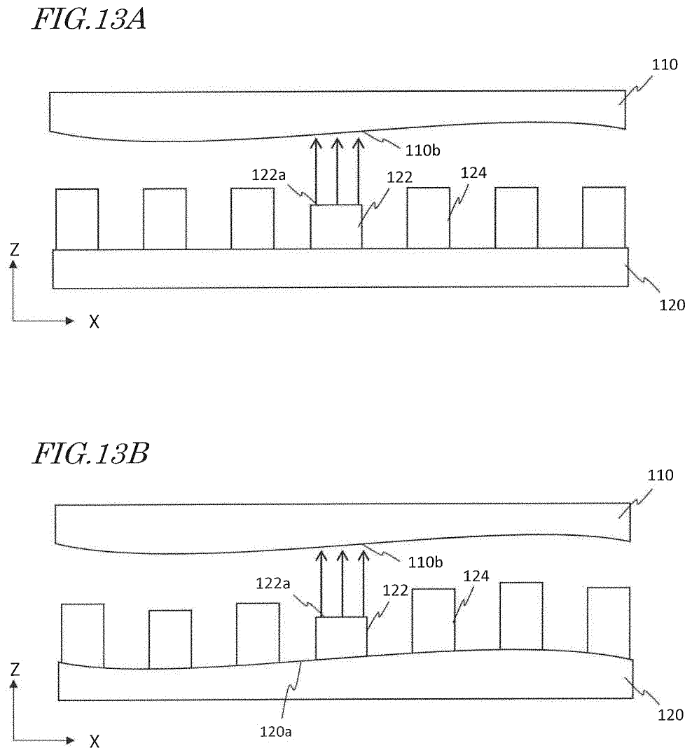

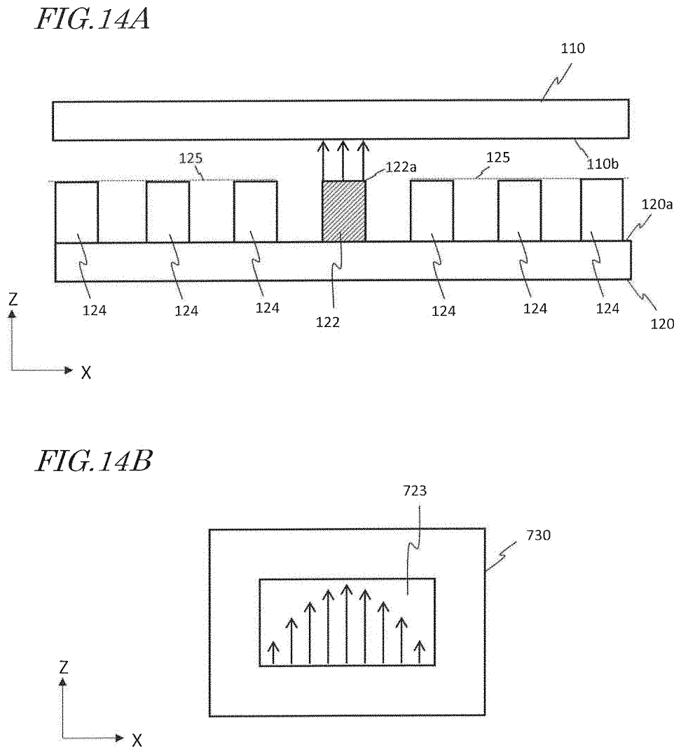

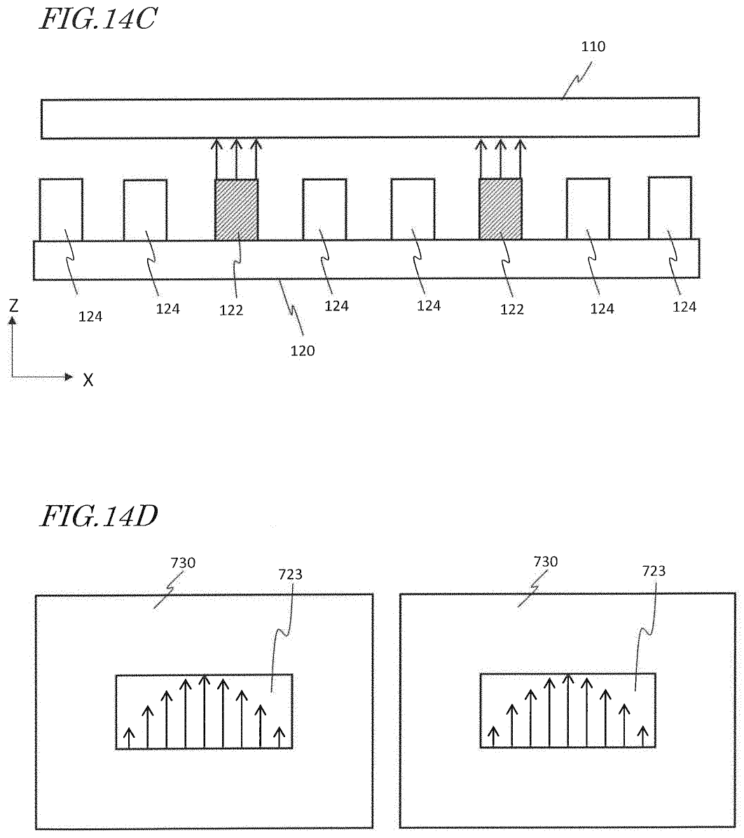

FIG. 14A schematically shows an electromagnetic wave that propagates in a narrow space, i.e., a gap between the waveguide face 122a of the waveguide member 122 and the conductive surface 110b of the conductive member 110. Three arrows in FIG. 14A schematically indicate the orientation of an electric field of the propagating electromagnetic wave. The electric field of the propagating electromagnetic wave is perpendicular to the conductive surface 110b of the conductive member 110 and to the waveguide face 122a.

On both sides of the waveguide member 122, stretches of artificial magnetic conductor that are created by the plurality of conductive rods 124 are present. An electromagnetic wave propagates in the gap between the waveguide face 122a of the waveguide member 122 and the conductive surface 110b of the conductive member 110. FIG. 14A is schematic, and does not accurately represent the magnitude of an electromagnetic field to be actually created by the electromagnetic wave. A part of the electromagnetic wave (electromagnetic field) propagating in the space over the waveguide face 122a may have a lateral expanse, to the outside (i.e., toward where the artificial magnetic conductor exists) of the space that is delineated by the width of the waveguide face 122a. In this example, the electromagnetic wave propagates in a direction (i.e., the Y direction) which is perpendicular to the plane of FIG. 14A. As such, the waveguide member 122 does not need to extend linearly along the Y direction, but may include a bend(s) and/or a branching portion(s) not shown. Since the electromagnetic wave propagates along the waveguide face 122a of the waveguide member 122, the direction of propagation would change at a bend, whereas the direction of propagation would ramify into plural directions at a branching portion.

In the waveguide structure of FIG. 14A, no metal wall (electric wall), which would be indispensable to a hollow waveguide, exists on both sides of the propagating electromagnetic wave. Therefore, in the waveguide structure of this example, “a constraint due to a metal wall (electric wall)” is not included in the boundary conditions for the electromagnetic field mode to be created by the propagating electromagnetic wave, and the width (size along the X direction) of the waveguide face 122a is less than a half of the wavelength of the electromagnetic wave.

For reference, FIG. 14B schematically shows a cross section of a hollow waveguide 730. With arrows, FIG. 14B schematically shows the orientation of an electric field of an electromagnetic field mode (TE₁₀) that is created in the internal space 723 of the hollow waveguide 730. The lengths of the arrows correspond to electric field intensities. The width of the internal space 723 of the hollow waveguide 730 needs to be set to be broader than a half of the wavelength. In other words, the width of the internal space 723 of the hollow waveguide 730 cannot be set to be smaller than a half of the wavelength of the propagating electromagnetic wave.

FIG. 14C is a cross-sectional view showing an implementation where two waveguide members 122 are provided on the conductive member 120. Thus, an artificial magnetic conductor that is created by the plurality of conductive rods 124 exists between the two adjacent waveguide members 122. More accurately, stretches of artificial magnetic conductor created by the plurality of conductive rods 124 are present on both sides of each waveguide member 122, such that each waveguide member 122 is able to independently propagate an electromagnetic wave.

For reference's sake, FIG. 14D schematically shows a cross section of a waveguiding device in which two hollow waveguides 730 are placed side-by-side. The two hollow waveguides 730 are electrically insulated from each other. Each space in which an electromagnetic wave is to propagate needs to be surrounded by a metal wall that defines the respective hollow waveguide 730. Therefore, the interval between the internal spaces 723 in which electromagnetic waves are to propagate cannot be made smaller than a total of the thicknesses of two metal walls. Usually, a total of the thicknesses of two metal walls is longer than a half of the wavelength of a propagating electromagnetic wave. Therefore, it is difficult for the interval between the hollow waveguides 730 (i.e., interval between their centers) to be shorter than the wavelength of a propagating electromagnetic wave. Particularly for electromagnetic waves of wavelengths in the extremely high frequency range (i.e., electromagnetic wave wavelength: 10 mm or less) or even shorter wavelengths, a metal wall which is sufficiently thin relative to the wavelength is difficult to be formed. This presents a cost problem in commercially practical implementation.

On the other hand, a waveguiding device 100 including an artificial magnetic conductor can easily realize a structure in which waveguide members 122 are placed close to one another. Thus, such a waveguiding device 100 can be suitably used in an antenna array that includes plural antenna elements in a close arrangement.

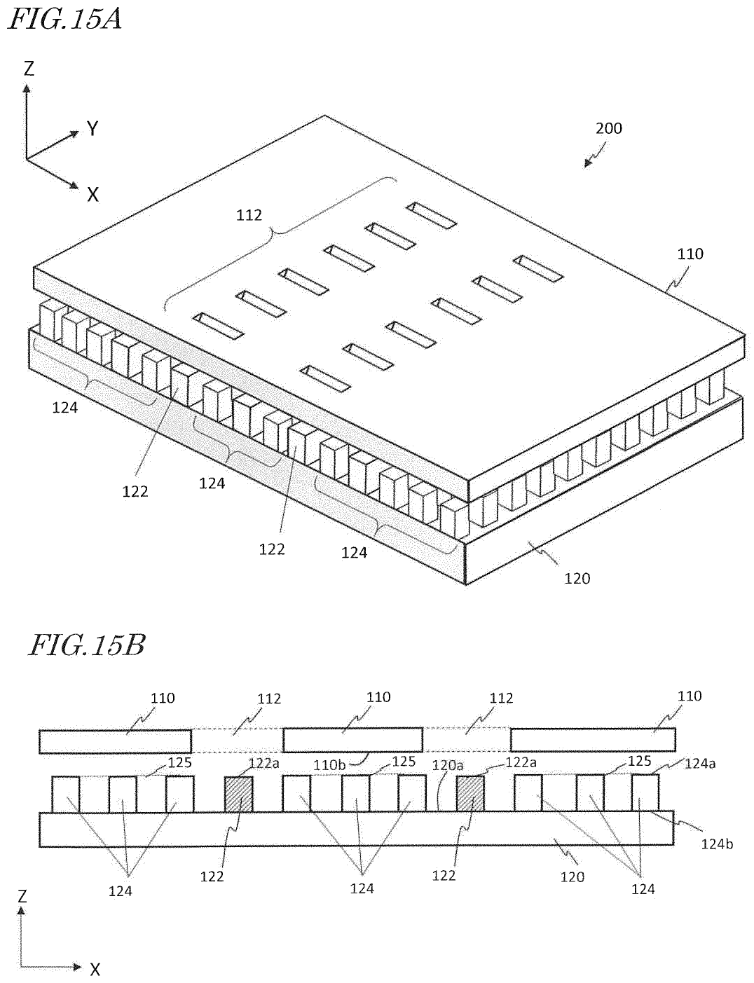

FIG. 15A is a perspective view schematically showing a portion of the construction of an antenna device 200 utilizing the aforementioned waveguide structure. FIG. 15B is a diagram showing schematically showing a portion of a cross section taken parallel to an XZ plane which passes through the centers of two adjacent slots 112 along the X direction of the antenna device 200. In the antenna device 200, the first conductive member 110 has a plurality of slots 112 arranged along the X direction and the Y direction. In this example, the plurality of slots 112 include two slot rows, each slot row including six slots 112 arranged at an equal interval along the Y direction. On the conductive member 120, two waveguide members 122 extending along the Y direction are provided. Each waveguide member 122 has an electrically-conductive waveguide face 122a opposing one slot row. In a region between the two waveguide members 122 and in regions outside of the two waveguide members 122, a plurality of conductive rods 124 are disposed. These conductive rods 124 constitute an artificial magnetic conductor.

From a transmission circuit not shown, an electromagnetic wave is supplied to a waveguide extending between the waveguide face 122a of each waveguide member 122 and the conductive surface 110b of the conductive member 110. Among the plurality of slots 112 arranged along the Y direction, the distance between the centers of two adjacent slots 112 is designed so as to be equal in value to the wavelength of an electromagnetic wave propagating in the waveguide, for example. As a result of this, electromagnetic waves with an equal phase can be radiated from the six slots 112 arranged along the Y direction.

The antenna device 200 shown in FIG. 15A and FIG. 15B is an antenna array in which the plurality of slots 112 serve as antenna elements (radiating elements). With such construction of the antenna device 200, the interval between the centers of antenna elements can be made shorter than a wavelength λo in free space of an electromagnetic wave propagating through the waveguide, for example. Horns may be provided for the plurality of slots 112. By providing horns, radiation characteristics or reception characteristics can be improved.

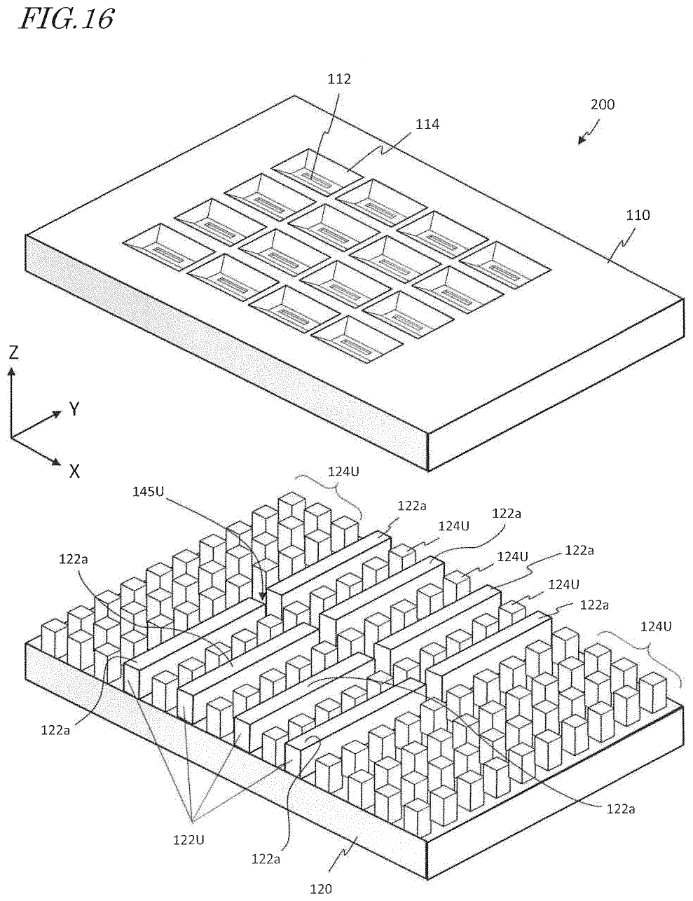

FIG. 16 is a perspective view schematically showing a portion of the structure of an antenna device 200 which has horn 114 for each slot 112. The antenna device 200 includes: a conductive member 110 having a plurality of slots 112 and a plurality of horns 114 arranged in a two-dimensional array; and a conductive member 120 on which a plurality of waveguide members 122U and a plurality of conductive rods 124U are arranged. FIG. 16 is illustrated so that the spacing between the conductive members 110 and 120 is exaggerated. The plurality of slots 112 in the conductive member 110 are arranged along the X direction and the along the Y direction. FIG. 16 also shows a port (throughhole) 145U that is disposed in the center of each waveguide member 122U. The choke structures which may be disposed at both ends of the waveguide member 122U are omitted from illustration. Although the present example embodiment illustrates that there are four waveguide members 122U, the number of waveguide members 122U may be arbitrary. In the present example embodiment, each waveguide member 122U is split into two portions at the position of the port 145U in the middle.

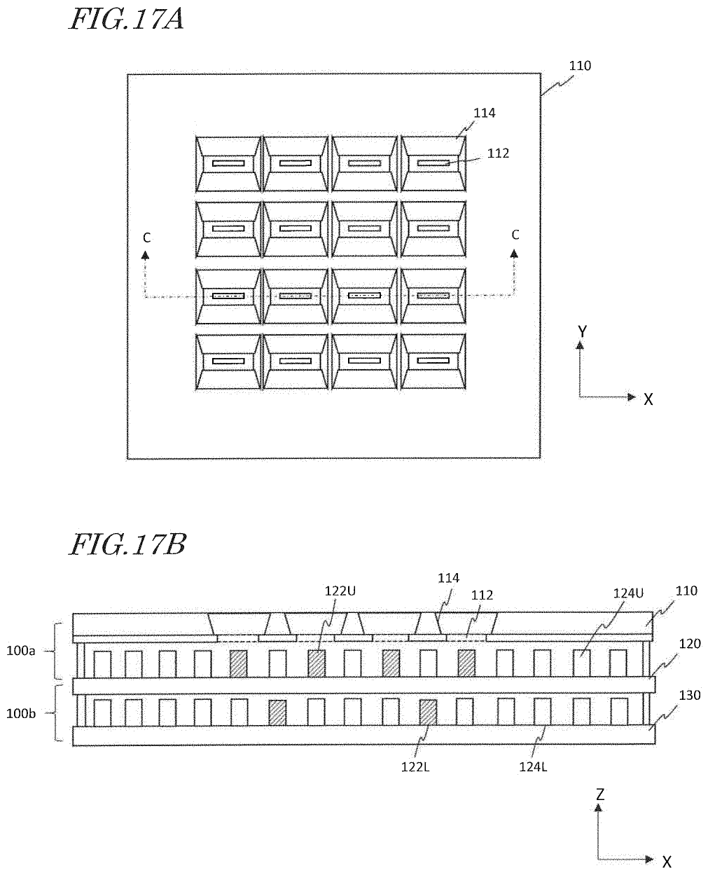

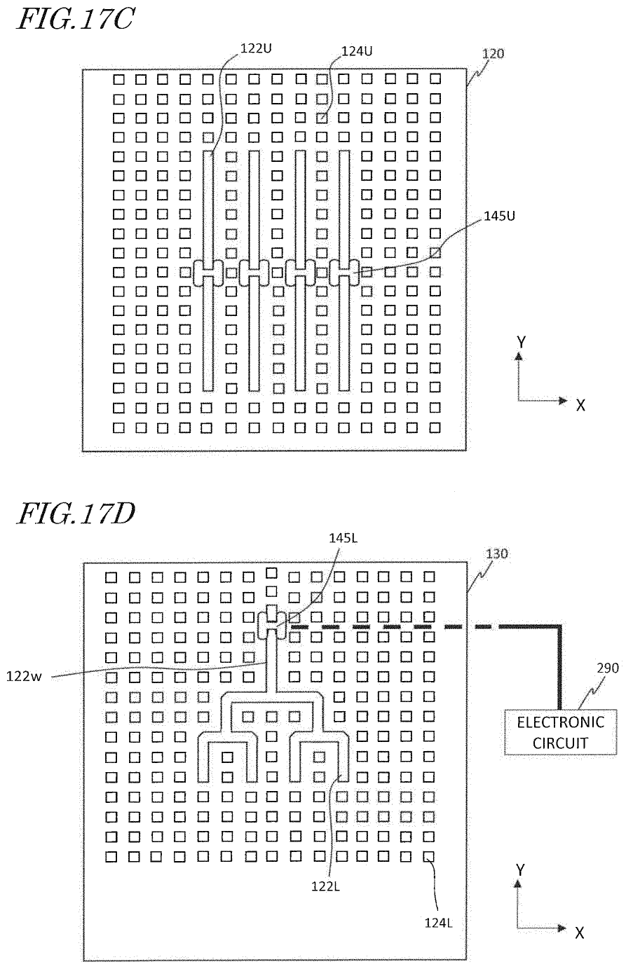

FIG. 17A is an upper plan view showing an antenna array 300 in which 16 slots are arranged in four rows and four columns as shown in FIG. 16, as viewed along the Z direction. FIG. 17B is a cross-sectional view taken along line C-C in FIG. 17A. The conductive member 110 in the antenna array 300 includes the plurality of horns 114, which are provided respectively corresponding to the plurality of slots 112. Each of the plurality of horns 114 includes four electrically conductive walls surrounding the slot 112. With such horns 114, directivity can be improved. Note that, instead of the structure shown in FIG. 16, each horn 114 may have a structure including a pair of ridges and a pair of side walls as shown in FIG. 1, for example. With such structure, influences of grating lobes can be suppressed as in the above-described example embodiments.

In the illustrated antenna device 200, a first waveguiding device 100a and a second waveguiding device 100b are layered, the first waveguiding device 100a including first waveguide members 122U that directly couple to the slots 112, and the second waveguiding device 100b including a second waveguide member 122L that couples to the waveguide members 122U on the first waveguiding device 100a. The waveguide member 122L and the conductive rods 124L of the second waveguiding device 100b are disposed on a conductive member 130. The second waveguiding device 100b basically has a similar construction to the construction of the first waveguiding device 100a.

As shown in FIG. 17A, the conductive member 110 includes a plurality of slots 112 that are arranged along the first direction (the Y direction) and the second direction (the X direction) which is orthogonal to the first direction. The waveguide faces 122a of the plurality of waveguide members 122U extend along the Y direction are opposed to four slots that are arranged side by side along the Y direction, among the plurality of slots 112. Although this example illustrates that the conductive member 110 has 16 slots 112 that are arranged in four rows and four columns, the number and arrangement of slots 112 are not limited to this example. Without being limited to the example where the waveguide members 122U are opposed to all slots among the plurality of slots 112 that are arranged side by side along the Y direction, there may be waveguide members 122U opposed to at least two adjacent slots along the Y direction. The interval between the centers of two adjacent waveguide faces 122a along the X direction may be set to be shorter than the wavelength λo, and more preferably shorter than the wavelength λo/2, for example.

FIG. 17C is a diagram showing a planar layout of the waveguide members 122U on the first waveguiding device 100a. FIG. 17D is a diagram showing a planar layout of the waveguide member 122L on the second waveguiding device 100b. As shown in these figures, the waveguide members 122U on the first waveguiding device 100a extend in linear shapes (stripes), without having any branching portions or bends. On the other hand, the waveguide member 122L on the second waveguiding device 100b includes both of branching portions and bends.

The waveguide members 122U on the first waveguiding device 100a couple to the waveguide member 122L on the second waveguiding device 100b via the ports 145U of the conductive member 120. In other words, an electromagnetic wave which has propagated along the waveguide member 122L on the second waveguiding device 100b passes through the port 145U to reach the waveguide member 122U on the first waveguiding device 100a, thereby being able to propagate through the waveguide member 122U on the first waveguiding device 100a. In this case, each slot 112 functions as an antenna element to allow an electromagnetic wave which has propagated through the waveguide to be radiated into space. Conversely, when an electromagnetic wave which has propagated in space impinges on a slot 112, the electromagnetic wave couples to the waveguide member 122U on the first waveguiding device 100a that lies immediately under that slot 112, and propagates along the waveguide member 122U on the first waveguiding device 100a. An electromagnetic wave which has propagated along a waveguide member 122U of the first waveguiding device 100a may also pass through the port 145U to reach the ridge 122L on the second waveguiding device 100b, and propagate along the ridge 122L.

As shown in FIG. 17D, the waveguide member 122L of the second waveguiding device 100b includes one stem-like portion and four branch-like portions which branch out from the stem-like portion. The stem-like portion of the waveguide member 122L extends along the Y direction, and is connected to a port 145L. Via an arbitrary waveguide, the port 145L is connected to an electronic circuit 290 that generates or receives a radio frequency signal.

Without being limited to a specific position, the electronic circuit 290 may be provided at any arbitrary position. The electronic circuit 290 may be provided on a circuit board which is on the rear surface side (i.e., the lower side in FIG. 17B) of the conductive member 130, for example. Such an electronic circuit may include a microwave integrated circuit, e.g. an MMIC (Monolithic Microwave Integrated Circuit) that generates or receives millimeter waves, for example. In addition to the microwave integrated circuit, the electronic circuit 290 may further include another circuit, e.g., a signal processing circuit. Such a signal processing circuit may be configured to execute various processes that are necessary for the operation of a radar system that includes an antenna device, for example. The electronic circuit 290 may include a communication circuit. The communication circuit may be configured to execute various processes that are necessary for the operation of a communication system that includes an antenna device.

The microwave integrated circuit is adapted so as to generate or process radio frequency signals. The microwave integrated circuit functions as at least one of a transmitter and a receiver. The electronic circuit 290 may include one or both of an A/D converter that is connected to a transmitter and a D/A converter that is connected to a receiver. The electronic circuit 290 may further include a signal processing circuit that is connected to one or both of an A/D converter and a D/A converter. The signal processing circuit performs at least one of encoding of digital signals and decoding of digital signals. Such a signal processing circuit will generate a signal to be transmitted by the antenna device, or process a signal received by the antenna device.

Note that a structure for connecting an electronic circuit to a waveguide is disclosed in, for example, US Patent Publication No. 2018/0351261, US Patent Publication No. 2019/0006743, US Patent Publication No. 2019/0139914, US Patent Publication No. 2019/0067780, US Patent Publication No. 2019/0140344, and International Patent Application Publication No. 2018/105513. The entire disclosure of these publications is incorporated herein by reference.

The conductive member 110 shown in FIG. 17A may be called a “radiation layer”. The layer containing the entirety of the conductive member 120, the waveguide members 122U, and the conductive rods 124U shown in FIG. 17C may be called an “excitation layer”; and the layer containing the entirety of the conductive member 130, the waveguide member 122L, and the conductive rods 124L shown in FIG. 17D may be called a “distribution layer”. Moreover, the “excitation layer” and the “distribution layer” may be collectively called a “feeding layer”. Each of the “radiation layer”, the “excitation layer” and the “distribution layer” can be mass-produced by processing a single metal plate. The radiation layer, the excitation layer, the distribution layer, and any electronic circuitry to be provided on the rear face side of the distribution layer may be produced as a single-module product.

In the antenna array of this example, as can be seen from FIG. 17B, a plate-like radiation layer, excitation layer, and distribution layer are layered, so that, as a whole, a flat panel antenna which is flat and low-profiled is realized. For example, the height (thickness) of a multilayer structure having a cross-sectional construction as shown in FIG. 17B can be made 10 mm or less.

The waveguide member 122L shown in FIG. 17D includes one stem-like portion that is connected to the port 145L, and four branch-like portions which branch out from the stem-like portion. The four ports 145U are respectively opposed to the upper faces of the leading ends of the four branch-like portions. The distances from the throughhole 212 to the four ports 145U of the conductive member 120 as measured along the waveguide member 122L are all equal. Therefore, a signal wave which is input from the throughhole 212 of the conductive member 130 to the waveguide member 122L reaches the four ports 145U, which are disposed in the center of the waveguide member 122U along the Y direction, all in the same phase. As a result, the four waveguide members 122U on the conductive member 120 can be excited in the same phase.

Depending on the application, it is not necessary for all slots 112 functioning as antenna elements to radiate electromagnetic waves in the same phase. The network patterns of the waveguide members 122U and 122L in the excitation layer and the distribution layer may be arbitrary, without being limited to what is shown in the figures.

When constructing an excitation layer and a distribution layer, various circuit elements in waveguides can be utilized. Examples thereof are disclosed in U.S. Pat. Nos. 10,042,045, 10,090,600, 10,158,158, International Patent Application Publication No. 2018/207796, International Patent Application Publication No. 2018/207838, and US Patent Publication No. 2019/0074569, for example. The entire disclosure of these publications is incorporated herein by reference.

An antenna device according to the present disclosure can be suitably used in a radar device or a radar system to be incorporated in moving entities such as vehicles, marine vessels, aircraft, robots, or the like, for example. A radar device would include an antenna device having the waveguiding device according to an example embodiment of the present disclosure and a microwave integrated circuit that is connected to the antenna device. A radar system would include the radar device and a signal processing circuit that is connected to the microwave integrated circuit of the radar device. When an antenna device according to an example embodiment of the present disclosure is combined with a WRG structure which permits downsizing, the area of the face on which the antenna elements are arranged can be reduced as compared to any construction using a conventional hollow waveguide. Therefore, a radar system incorporating the antenna device can be easily installed even in a narrow place. The radar system may be fixed to a road or a building in use, for example. The signal processing circuit may perform a process of estimating the azimuth of an arriving wave based on a signal that is received by a microwave integrated circuit, for example. For example, the signal processing circuit may be configured to execute the MUSIC method, the ESPRIT method, the SAGE method, or other algorithms to estimate the azimuth of the arriving wave, and output a signal indicating the estimation result. Furthermore, the signal processing circuit may be configured to estimate the distance to each target as a wave source of an arriving wave, the relative velocity of the target, and the azimuth of the target by using a known algorithm, and output a signal indicating the estimation result.

In the present disclosure, the term “signal processing circuit” is not limited to a single circuit, but encompasses any implementation in which a combination of plural circuits is conceptually regarded as a single functional part. The signal processing circuit may be realized by one or more System-on-Chips (SoC). For example, a part or a whole of the signal processing circuit may be an FPGA (Field-Programmable Gate Array), which is a programmable logic device (PLD). In that case, the signal processing circuit includes a plurality of computation elements (e.g., general-purpose logics and multipliers) and a plurality of memory elements (e.g., look-up tables or memory blocks). Alternatively, the signal processing circuit may be a set of a general-purpose processor(s) and a main memory device(s). The signal processing circuit may be a circuit which includes a processor core(s) and a memory device(s). These may function as the signal processing circuit.

An antenna device according to an example embodiment of the present disclosure can also be used in a wireless communication system. Such a wireless communication system would include an antenna device having the waveguiding device according to any of the above example embodiments and a communication circuit (a transmission circuit or a reception circuit) connected to the antenna device. For example, the transmission circuit may be configured to supply, to a waveguide within the antenna device, a signal wave representing a signal for transmission. The reception circuit may be configured to demodulate a signal wave which has been received via the antenna device, and output it as an analog or digital signal.

An antenna device according to an example embodiment of the present disclosure can further be used as an antenna in an indoor positioning system (IPS). An indoor positioning system is able to identify the position of a moving entity, such as a person or an automated guided vehicle (AGV), that is in a building. An antenna device can also be used as a radio wave transmitter (beacon) for use in a system which provides information to an information terminal device (e.g., a smartphone) that is carried by a person who has visited a store or any other facility. In such a system, once every several seconds, a beacon may radiate an electromagnetic wave carrying an ID or other information superposed thereon, for example. When the information terminal device receives this electromagnetic wave, the information terminal device transmits the received information to a remote server computer via telecommunication lines. Based on the information that has been received from the information terminal device, the server computer identifies the position of that information terminal device, and provides information which is associated with that position (e.g., product information or a coupon) to the information terminal device.

Application examples of radar systems, communication systems, and various monitoring systems that include a slot array antenna having a WRG structure are disclosed in the specifications of U.S. Pat. Nos. 9,786,995 and 10,027,032, for example. The entire disclosure of these publications is incorporated herein by reference. A slot array antenna according to the present disclosure is applicable to each application example that is disclosed in these publications.

A waveguiding device according to the present disclosure is usable in any technological field that utilizes an antenna. For example, it is available to various applications where transmission/reception of electromagnetic waves of the gigahertz band or the terahertz band is performed. In particular, they may be suitably used in onboard radar systems, various types of monitoring systems, indoor positioning systems, and wireless communication systems, e.g., Massive MIMO, where downsizing is desired.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An antenna device comprising:
an electrical conductor including an electrically conductive surface and a slot that opens in the electrically conductive surface;
a pair of electrically-conductive side walls on opposite sides of the slot and protruding from the electrically conductive surface, the pair of side walls flanking each other along a first direction, and each extending along a second direction that intersects the first direction; and
a pair of electrically-conductive ridges each protruding from the electrically conductive surface and extending along the second direction and including an end surface, the respective end surfaces of the pair of ridges opposing each other via a gap that overlaps a central portion of the slot as viewed from a third direction that is perpendicular to the electrically conductive surface; wherein
a waveguide that is continuous with an external space is defined in a space inside the slot and between the end surfaces of the pair of ridges.

2. The antenna device of claim 1, further comprising a pair of electrically conductive walls respectively located, via a gap, on opposite and farther sides of the pair of side walls.

3. The antenna device of claim 1, wherein each of the pair of side walls includes a side surface that is continuous with an inner surface of the slot so as to define one integral surface therewith.

4. The antenna device of claim 1, wherein
one end of each of the pair of ridges is located between the pair of side walls; and
a height of the pair of side walls as measured from the electrically conductive surface is greater than a height of the pair of ridges at the one end as measured from the electrically conductive surface.

5. The antenna device of claim 1, further comprising a pair of electrically conductive walls respectively located, via a gap, on opposite and farther sides of the pair of side walls.

6. The antenna device of claim 1, wherein
an inner surface of the slot includes two opposing surfaces spaced apart by a locally-diminished distance along the second direction;
the end surfaces of the pair of ridges are respectively continuous with the two opposing surfaces; and
an interval between the two opposing surfaces and an interval between the end surfaces increase toward the external space.

7. The antenna device of claim 1, wherein
each of the pair of ridges includes a top surface intersecting the end surface and extending along the second direction; and
the top surface includes a section in which a height of the top surface as measured from the electrically conductive surface decreases in a gradual or stepwise manner toward the end surface.

8. The antenna device of claim 1, wherein
an inner surface of the slot includes two opposing surfaces spaced apart by a locally-diminished distance along the second direction;
the end surfaces of the pair of ridges are respectively continuous with the two opposing surfaces;
an interval between the two opposing surfaces and an interval between the end surfaces increase toward the external space;
each of the pair of ridges includes a top surface intersecting the end surface and extending along the second direction; and
the top surface includes a section in which a height of the top surface as measured from the electrically conductive surface decreases in a gradual or stepwise manner toward the end surface.

9. The antenna device of claim 1, wherein
one end of each of the pair of ridges protrudes into the slot as viewed from the third direction.

10. The antenna device of claim 1, wherein
as viewed from the third direction, the slot has a shape that includes:
a lateral portion extending along the first direction; and
a pair of vertical portions each being continuous with the lateral portion and extending along the second direction;
the gap between the end surfaces of the pair of ridges overlaps the lateral portion of the slot; and
the pair of side walls are respectively adjacent to the pair of vertical portions.

11. The antenna device of claim 1, wherein
an inner surface of the slot includes two opposing surfaces spaced apart by a locally-diminished distance along the second direction;
the end surfaces of the pair of ridges are respectively continuous with the two opposing surfaces;
an interval between the two opposing surfaces and an interval between the end surfaces increase toward the external space;
each of the pair of ridges includes a top surface intersecting the end surface and extending along the second direction;
the top surface includes a section in which a height of the top surface as measured from the electrically conductive surface decreases in a gradual or stepwise manner toward the end surface;
as viewed from the third direction, the slot has a shape that includes:
a lateral portion extending along the first direction; and
a pair of vertical portions each being continuous with the lateral portion and extending along the second direction;
the gap between the end surfaces of the pair of ridges overlaps the lateral portion of the slot; and
the pair of side walls are respectively adjacent to the pair of vertical portions.

12. The antenna device of claim 1, wherein
the electrical conductor includes a plurality of slots, including the slot;
the antenna device includes:
a plurality of pairs of electrically-conductive side walls, including the pair of side walls; and
a plurality of pairs of electrically-conductive ridges, including the pair of ridges; wherein
side walls in each pair among the plurality of pairs of side walls are disposed on opposite sides of a corresponding slot among the plurality of slots and protrude from the electrically conductive surface, the side walls flanking each other along the first direction, and each of the side walls extending along the second direction;
ridges in each pair among the plurality of pairs of ridges protrude from the electrically conductive surface, extend along the second direction, and each includes an end surface, the respective end surfaces of the pair of ridges opposing each other via a gap that overlaps a central portion of a corresponding slot among the plurality of slots as viewed from the third direction; and
a plurality of waveguides are defined inside the plurality of slots and in the gap between the end surfaces of the plurality of pairs of ridges.

13. The antenna device of claim 1, wherein
one end of each of the pair of ridges is located between the pair of side walls;
a height of the pair of side walls as measured from the electrically conductive surface is greater than a height of the pair of ridges at the one end as measured from the electrically conductive surface;
the electrical conductor includes a plurality of slots, including the slot;
the antenna device includes:
a plurality of pairs of electrically-conductive side walls, including the pair of side walls; and
a plurality of pairs of electrically-conductive ridges, including the pair of ridges;
side walls in each pair among the plurality of pairs of side walls are disposed on opposite sides of a corresponding slot among the plurality of slots and protrude from the electrically conductive surface, the side walls flanking each other along the first direction, and each side wall extending along the second direction;
ridges in each pair among the plurality of pairs of ridges protrude from the electrically conductive surface, extend along the second direction, and each includes an end surface, the respective end surfaces of the pair of ridges opposing each other via a gap that overlaps a central portion of a corresponding slot among the plurality of slots as viewed from the third direction; and
a plurality of waveguides are defined inside the plurality of slots and in the gap between the end surfaces of the plurality of pairs of ridges.

14. The antenna device of claim 6, wherein
the electrical conductor includes a plurality of slots, including the slot;
the antenna device includes:
a plurality of pairs of electrically-conductive side walls, including the pair of side walls; and
a plurality of pairs of electrically-conductive ridges, including the pair of ridges;
side walls in each pair among the plurality of pairs of side walls are disposed on opposite sides of a corresponding slot among the plurality of slots and protrude from the electrically conductive surface, the side walls flanking each other along the first direction, and each side wall extending along the second direction;
ridges in each pair among the plurality of pairs of ridges protrude from the electrically conductive surface, extend along the second direction, and each includes an end surface, the respective end surfaces of the pair of ridges opposing each other via a gap that overlaps a central portion of a corresponding slot among the plurality of slots as viewed from the third direction; and
a plurality of waveguides are defined inside the plurality of slots and in the gap between the end surfaces of the plurality of pairs of ridges.

15. The antenna device of claim 12, wherein
the plurality of slots include a first slot and a second slot flanking each other along the first direction;
the plurality of pairs of side walls include a first side wall pair located on opposite sides of the first slot and a second side wall pair located on opposite sides of the second slot; and
one side wall in the first side wall pair is one side wall in the second side wall pair.

16. The antenna device of claim 12, wherein
the plurality of slots include a first slot and a second slot flanking each other along the first direction; and
within the electrically conductive surface, a portion that is located between a root of one of the pair of ridges that is continuous with the first slot and a root of one of the pair of ridges that is continuous with the second slot defines a flat surface or a concave surface.

17. The antenna device of claim 12, wherein
the plurality of slots include a first slot and a third slot flanking each other along the second direction; and
one of the pair of ridges that is continuous with the first slot and one of the pair of ridges that is continuous with the third slot are each a portion of a single ridge-shaped structure.

18. The antenna device of claim 12, wherein the plurality of slots include:
a first slot;
a second slot spaced from the first slot by a first interval along the first direction; and
a third slot spaced from the first slot by a second interval along the second direction, the second interval being greater than the first interval.

19. The antenna device of claim 12, wherein
the plurality of slots include two or more slots flanking each other along the second direction; and
the antenna device further comprises a pair of electrically conductive walls respectively located, via a gap, on opposite and farther sides of two or more side walls among the plurality of pairs of side walls that are disposed on opposite sides of the two or more slots.

20. The antenna device of claim 12, further comprising a pair of electrically conductive walls respectively located, via a gap, on opposite sides of the entirety of the plurality of pairs of side walls.

21. The antenna device of claim 1, wherein
the electrical conductor is a first electrical conductor;
the electrically conductive surface is a first electrically conductive surface; and
the first electrical conductor includes a second electrically conductive surface on an opposite side to the first electrically conductive surface;
the antenna device further comprising:
a second electrical conductor including a third electrically conductive surface opposing the second electrically conductive surface;
a ridge-shaped waveguide protruding from the third electrically conductive surface and extending along the second direction, the ridge-shaped waveguide including an electrically-conductive waveguide surface opposing the second electrically conductive surface and the slot; and
a plurality of electrically conductive rods disposed on opposite sides of the ridge-shaped waveguide and protruding from the third electrically conductive surface, each of the plurality of electrically conductive rods including a leading end opposing the second electrically conductive surface.

22. The antenna device of claim 1, wherein
the electrical conductor include a plurality of slots, including the slot;
the antenna device includes:
a plurality of pairs of electrically-conductive side walls, including the pair of side walls; and
a plurality of pairs of electrically-conductive ridges, including the pair of ridges;
side walls in each pair among the plurality of pairs of side walls are disposed on opposite sides of a corresponding slot among the plurality of slots and protrude from the electrically conductive surface, the side walls flanking each other along the first direction, and each side wall extending along the second direction;
ridges in each pair among the plurality of pairs of ridges protrude from the electrically conductive surface, extend along the second direction, and each include an end surface, the respective end surfaces of the pair of ridges opposing each other via a gap that overlaps a central portion of a corresponding slot among the plurality of slots as viewed from the third direction;
a plurality of waveguides are defined inside the plurality of slots and in the gap between the end surfaces of the plurality of pairs of ridges;
the electrical conductor is a first electrical conductor;
the electrically conductive surface is a first electrically conductive surface; and
the first electrical conductor includes a second electrically conductive surface on an opposite side to the first electrically conductive surface;
the antenna device further comprising:
a second electrical conductor including a third electrically conductive surface opposing the second electrically conductive surface;
a ridge-shaped waveguide protruding from the third electrically conductive surface and extending along the second direction, the ridge-shaped waveguide including an electrically-conductive waveguide surface opposing the second electrically conductive surface and the slot; and
a plurality of electrically conductive rods disposed on opposite sides of the ridge-shaped waveguide and protruding from the third electrically conductive surface, each of the plurality of electrically conductive rods including a leading end opposing the second electrically conductive surface.

23. A radar system comprising:
the antenna device of claim 1;
at least one of a transmitter and a receiver that is connected to the antenna device;
at least one of a D/A converter that is connected to the transmitter and an A/D converter that is connected to the receiver; and
a signal processing circuit that is connected to the at least one of the D/A converter and the A/D converter; wherein
the at least one of the transmitter and the receiver includes a microwave integrated circuit; and
the signal processing circuit performs at least one of direction-of-arrival estimation and distance estimation.

24. A radar system comprising:
the antenna device of claim 18;
at least one of a transmitter and a receiver that is connected to the antenna device;
at least one of a D/A converter that is connected to the transmitter and an A/D converter that is connected to the receiver; and
a signal processing circuit that is connected to the at least one of the D/A converter and the A/D converter; wherein
the at least one of the transmitter and the receiver includes a microwave integrated circuit; and
the signal processing circuit performs at least one of direction-of-arrival estimation and distance estimation.

25. A communication system comprising:
the antenna device of claim 1;
at least one of a transmitter and a receiver that is connected to the antenna device;
at least one of a D/A converter that is connected to the transmitter and an A/D converter that is connected to the receiver; and
a signal processing circuit that is connected to the at least one of the D/A converter and the A/D converter; wherein
the signal processing circuit performs at least one of encoding of a digital signal and decoding of a digital signal.

26. A communication system comprising:
the antenna device of claim 18;
at least one of a transmitter and a receiver that is connected to the antenna device;
at least one of a D/A converter that is connected to the transmitter and an A/D converter that is connected to the receiver; and
a signal processing circuit that is connected to the at least one of the D/A converter and the A/D converter; wherein
the signal processing circuit performs at least one of encoding of a digital signal and decoding of a digital signal.
